(19) United States
(12) Patent Application Publication
(10) Pub. No.: US 2014/0204740 A1
(43) Pub. Date: Jul. 24, 2014

(54) BUS SYSTEM AND ROUTER

(71) Applicant: Panasonic Corporation, Osaka (JP)

(72) Inventors: Satoru TOKUTSU, Saitama (JP); Tomoki ISHII, Kyoto (JP); Atsushi YOSHIDA, Osaka (JP); Takao YAMAGUCHI, Osaka (JP); Takashi YAMADA, Hyogo (JP)

(73) Assignee: Panasonic Corporation, Osaka (JP)

(21) Appl. No.: 14/221,619

(22) Filed: Mar. 21, 2014

Related U.S. Application Data
(63) Continuation of application No. PCT/JP2013/004449, filed on Jul. 22, 2013.

(30) Foreign Application Priority Data
Jul. 24, 2012 (JP) 2012-163833

(51) Int. Cl. H04L 12/851

(52) U.S. Cl. CPC H04L 47/2441
USPC 370/230

(57) ABSTRACT

In an NoC bus system, data is transmitted between first and second nodes through a router. The data includes performance-ensuring data which guarantees throughput and/or a permitted time delay. The first node generates packets, each including the data to be transmitted and classification information that indicates the class of that data to be determined according to its required performance, and controls transmission of the packets. The router includes a buffer section configured to store the received packets separately after having classified the packets according to their required performance by reference to the classification information, and a relay controller configured to control transmission of the packets stored in the buffer section at a transmission rate which is equal to or higher than the sum of transmission rates to be guaranteed for every first node associated with the classification information by reference to each piece of the classification information.

This is a continuation of International Application No. PCT/JP2013/004449, with an international filing date of Jul. 22, 2013, which claims priority of Japanese Patent Application No. 2012-163833, filed on Jul. 24, 2012, the contents of which are hereby incorporated by reference.

### BACKGROUND

1. Technical Field

The present application relates to a technology for controlling a network of communications buses (distributed buses) provided for a bus system in a semiconductor integrated circuit.

2. Description of the Related Art

An NoC (Network-on-Chip) is a network of communications buses to be provided on a semiconductor chip which is a semiconductor integrated circuit. In an NoC, buses are connected together via routers and traffic flows are transmitted from a plurality of masters through the same bus shared. As a result, the number of buses to use can be cut down and the buses can be used more efficiently.

In an NoC, however, a bus is shared by traffic flows coming from multiple masters, and therefore, it is difficult to ensure performance (more specifically, to ensure throughput and delay).

Those multiple masters pass traffic flows which require mutually different kinds of performances independently of each other. As a result, a traffic flow which needs to be transmitted with as short a time delay as possible (i.e., a traffic flow of time-delay-guaranteed type), a traffic flow which always needs to be transmitted in a constant transmission quantity for sure (i.e., a traffic flow of throughput guaranteed type) and a traffic flow which needs to transmit a huge size of data at irregular intervals will be transmitted through the same bus as a mix.

As for an NoC, it is important to realize a performance ensuring scheme for satisfying the performance required by each traffic flow (in terms of at least one of throughput and time delay) at a minimum required bus bandwidth. If the performance of an NoC is ensured, the buses can be used more efficiently and the NoC can be designed at the minimum required bus bandwidth to satisfy the required performance. As a result, the hardware design and development of buses can be carried out more easily.

Some conventional routers determine the levels of priority of a given traffic flow. If the data of a traffic flow of a high level of priority is stored in a buffer, then such a router performs transmission processing with the level of priority of that buffer switched to a high level. FIG. 1A illustrates an exemplary configuration for a router 301 which outputs the data of traffic flows with high levels of priorities that are stored in buffers 304 and 303 earlier than the traffic flow stored in the other buffer 301. In FIG. 1A, the numerals indicate the respective levels of priorities, and the larger a numeral, the higher the level of priority indicated by the numeral is. The router 301 determines, according to the levels of priorities of the data that are stored at the respective tops of the input buffers, which traffic flows should be provided as output data.

In such a router, however, traffic flows with mutually different levels of priorities can be present in the same buffer. As a result, a traffic flow with a high level of priority will be interfered with by a traffic flow with a low level of priority, which is a problem.

Techniques for coping with such a problem are disclosed in, for example:

United States Laid-Open Patent Publication No. 2005/0117589; and

Jean-Jacques Lecler and Gilles Baillieu, “Application Driven Network on Chip Architecture Exploration and Refinement for a Complex SoC”, Springer Verlag's Design Automation for Embedded Systems Journal, Volume 15, Number 2, pp. 133-158.

FIG. 1B illustrates a modified configuration for the router 301 shown in FIG. 1A. Specifically, in the router 301 shown in FIG. 1B, the level of priority of each input buffer is determined by the highest level of priority of the messages stored there, and the data is output according to the respective levels of priorities of the input buffers.

In the example illustrated in FIG. 1B, one message, of which the level of priority is Level 3, and three messages, of which the level of priority is Level 1, are stored in the input buffer 302. Two messages, of which the level of priority is Level 2, and two messages, of which the level of priority is Level 1, are stored in the input buffer 303. And one message, of which the level of priority is Level 1, one message, of which the level of priority is Level 2, and two messages, of which the level of priority is Level 3, are stored in the input buffer 304.

The priority level of each input buffer is determined by the highest priority level of the messages stored in that input buffer. That is why the priority levels of the input buffers 302, 303 and 304 become Levels 3, 2 and 3, respectively. Since the messages are sent in the descending order of priorities, the messages stored at the respective tops of the input buffers 302 and 304 are sent as a result.

Thus, the input buffer 302 that stores a message, of which the level of priority is Level 3, can advance the transmission processing preferentially without depending on the levels of priorities of the preceding messages stored. Consequently, the time delay of such a message with a high level of priority can be reduced even if the preceding space of the buffer is occupied with messages with a low level of priority.

### SUMMARY

The prior art technique needs further improvement in view of performance on an NOC.

One non-limiting, and exemplary embodiment provides a technique to improve higher performance on an NOC.

In one general aspect, disclosed herein is a bus system for a semiconductor circuit to transmit data between a first node and at least one second node through a network of buses and at least one router which is arranged on any of the buses. The data to be transmitted includes performance-ensuring data which guarantees at least one of throughput and a permitted time delay. The first node includes: a packet generator which generates a plurality of packets, each of which includes the data to be transmitted and classification information that indicates the class of the data to be transmitted to be determined according to its required performance; and a transmission controller which controls transmission of the packets. The at least one router includes: a buffer section which stores the received packets separately after having classified the packets according to their required performance by reference to the classification information; and a relay controller which controls transmission of the packets that are stored in the buffer section at a transmission rate which is equal to or higher than the sum of transmission rates to be guaranteed for every first node associated with the classification information by reference to each piece of the classification information.

According to the above aspect, by adopting a buffer which is configured to change the data to be transmitted according to the required performance and by adjusting the transmission schedule between a master and a router, the router can minimize mutual interference and the bus' operating frequency to ensure the required performance can be estimated to be a low value. For example, since a traffic flow in a performance ensured class with a high priority level can be transmitted without being interfered with by a traffic flow in a non-performance-ensured class with a low priority level, the rate of the traffic flow to interfere when the bus bandwidth is estimated can be reduced. As a result, a bus of which the performance can be ensured at a low operating frequency can be established without making overestimation. In addition, the extra bus band to be produced by worst estimation can be reduced as much as possible by adjusting the transmission schedule between the master and the router. In other words, the extra bus band can be used more efficiently.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1A illustrates an exemplary configuration for a router 301 which outputs the data of traffic flows with high levels of priorities that are stored in buffers 304 and 303 earlier than the traffic flow stored in the other buffer 301.

FIG. 1B illustrates a modified configuration for the router 301 shown in FIG. 1A in which the level of priority of each input buffer is determined by the highest level of priority of the messages stored there, and the data is output according to the respective levels of priorities of the input buffers.

FIG. 2 shows a processing policy according to this embodiment to be applied to the performance-ensured class and the non-performance-ensured class.

FIG. 3 illustrates an exemplary NoC which is implemented using routers 103 as an embodiment of the present invention.

FIG. 4 shows the concepts of respective components of an NoC.

FIG. 5 schematically illustrates a configuration for the NoC shown in FIG. 3.

FIGS. 6A and 6B show exemplary transmission rate values to be set for respective routers.

FIGS. 7A and 7B show how the effect achieved varies depending on whether the configuration of the router 103 is applied to the Internet or to a semiconductor bus system.

FIG. 8 is a flowchart showing the procedure of operation of an NoC including routers according to an embodiment of the present invention.

FIG. 9 shows the rule of classifying bus masters so that performance-ensuring data and non-performance-ensuring data can be distinguished from each other, to say the least, in order to lower an estimated bus' operating frequency required.

FIG. 10 shows specific exemplary definitions of specifications required for traffic flows to be generated by masters.

FIG. 11 shows respective classes to which the bus masters 101 are grouped and their specific examples.

FIG. 12 illustrates a configuration for a master NIC 102.

FIG. 13 shows the flow of operation of the master NIC 102.

FIG. 14 illustrates a data structure for each packet 202.

FIG. 15 illustrates a configuration for a rate controller 804 provided for the master NIC 102.

FIG. 16 shows a rate value stored in a rate value storage 1003.

FIG. 17 shows the flow of operation of a rate controller 804.

FIG. 18 shows how a transmission determination circuit 1001 performs transmission determining processing step S1103.

FIG. 19 shows the flow of operation of a timer processor 1002.

FIG. 20 illustrates how to carry out a general flow control between the master NIC 102 and the router 103.

FIGS. 21A and 21B show how a flow control and a rate control are different.

FIG. 22 illustrates a configuration for the router 103.

FIG. 23 shows class priority level information to be stored in class information storage 1411.

FIG. 24 shows a specific example of the results of arbitration conducted by the output arbitrator 1410 of the router 103 between respective buffers to transmit packets from in order to determine their order of priorities.

FIG. 25 shows the flow of operation of the router 103.

FIG. 26 shows what is input to, and output from, the class analyzer 1403 of the router 103.

FIG. 27 illustrates a configuration for the rate controller 1409 of the router 103.

FIG. 28 shows the flow of operation of the rate controller 1409.

FIG. 29 shows the procedure in which the rate controller 1409 performs transmission determining processing step.

FIG. 30 shows a specific example of the management information for the timer processor.

FIG. 31 shows the flow of operation of the timer processor 2002 of the rate controller 1409.

FIG. 32 shows exemplary transmission rate values that are managed by the rate value storage 2003 on a class-by-class basis.

FIG. 33 shows the flow of operation of an output arbitrator 1410.

FIG. 34 is a flowchart showing how the output arbitrator 1410 carries out the processing step S2805 of conducting arbitration between the input buffers 1415 to transmit packets from.

FIG. 35 shows a specific exemplary format for management information to be stored in the buffer information storage 1407 of the router 103.

FIG. 36 illustrates exemplary NoCs which can be used as other embodiments of the present invention.

FIG. 37 illustrates an exemplary buffer arrangement to be adopted in a situation where a command and data are separated from each other.

FIGS. 38A and 38B show how the delay involved with a command can be shortened, which is an effect to be achieved by separating the command and data from each other.

FIG. 39 shows generally how to multiplex and transmit a packet.

FIG. 40 illustrates how packets may be transmitted depending on whether the packets are multiplexed or not.

FIG. 41 illustrates a packet multiplexing format for a packet 202.

FIG. 42 is a flowchart showing how the master NIC 102 operates to get packet multiplexing done.

FIG. 43 illustrates a packet multiplexing configuration for a slave NIC 104.

FIG. 44 shows the flow of packet multiplexing operation of the slave NIC 104.

FIG. 45 illustrates an example in which multiple masters and multiple memories on a semiconductor circuit and common input/output (I/O) ports to exchange data with external devices are connected together with distributed buses.

FIG. 46 illustrates a multi-core processor in which a number of core processors such as a CPU, a GPU and a DSP are arranged in a mesh pattern and connected together with distributed buses in order to improve the processing performance of these core processors.

FIG. 47 illustrates how classification may be done according to the priority level of a time-delay-guaranteed class.

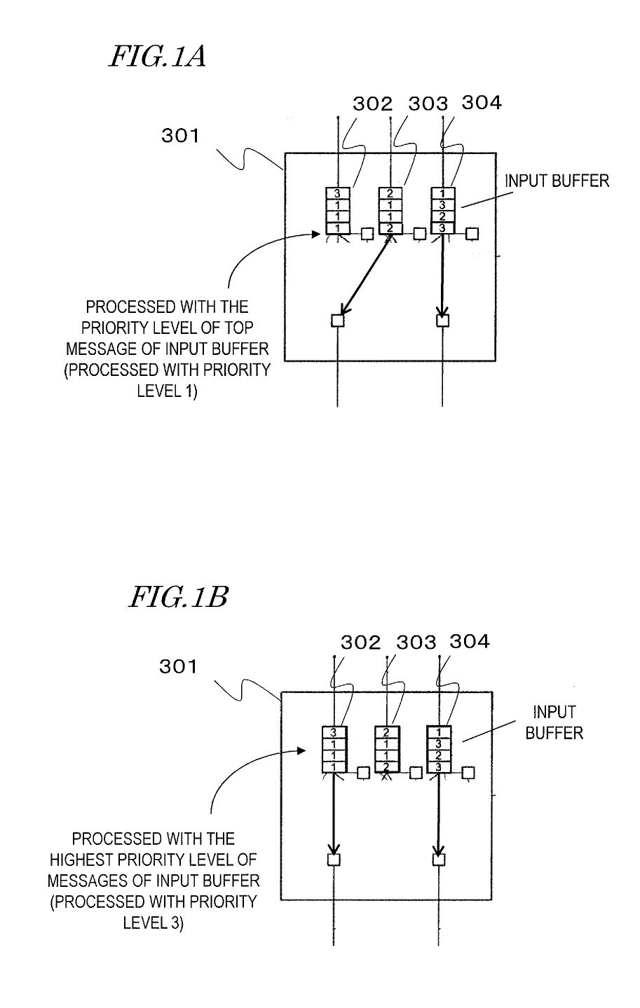

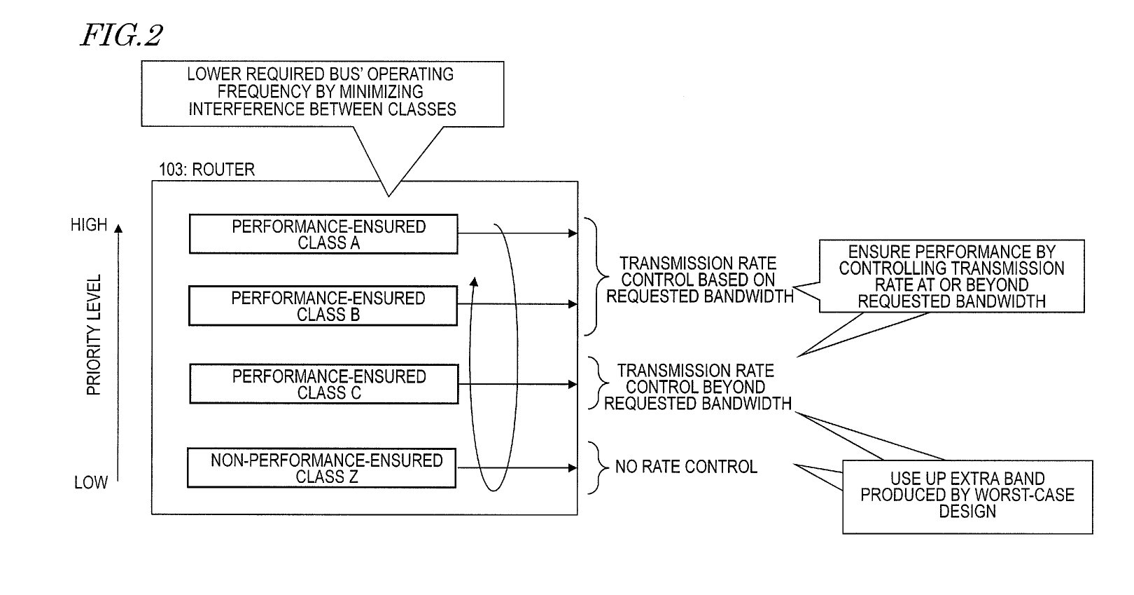

### DETAILED DESCRIPTION

According to the conventional method, however, it is not until the other messages that have been stored in advance have been transmitted, to say the least, that such a message with a high level of priority is transmitted. For that reason, the time delay caused by a router to such a message with a high level of priority is affected by other messages with a low level of priority, and therefore, tends to be a significant one.

To ensure performance under such a condition, the bandwidth provided should be significantly broader than what is actually needed. In addition, the transmission bandwidth required varies according to the ratio of high and low levels of priorities in a buffer.

According to an exemplary embodiment of the present invention, a bus' band is obtained so as not to be overestimated with respect to the performance required for each traffic flow running through the bus. After that, the bus' extra band to be produced by being estimated in a worst case scenario is cut down as much as possible.

Before exemplary embodiments of the present disclosure are described, the terms to be used in this description will be defined. It should be noted that some terms other than the following ones will also be defined as needed in the following description of embodiments.

“To have a burst property” refers herein to a situation where while a bus master is transmitting the communication data of traffic flows continuously, those traffic flows have only a short permitted time delay or request a broad bandwidth. As such communication data to be transmitted by a bus master with a burst property, video based data may be classified, for example. On the other hand, as communication data in a time-delay-guaranteed class with no burst property, USB data may be classified. It is determined from a designer's point of view whether given data has a burst property or not.

The “non-performance-ensuring data” is data which needs to guarantee neither throughput nor time delay.

The “requested bandwidth” refers herein to the transmission quantity per unit time of a traffic flow, of which the throughput is guaranteed.

The “deadline” of a traffic flow refers herein to a time by which the traffic flow is supposed to arrive at its destination (i.e., slave) as specified by a bus master that has started to transmit the traffic flow.

For example, according to exemplary embodiments of the present invention, the bus system and router to be described below can be obtained.

Specifically, an embodiment provides a bus system for a semiconductor circuit to transmit data between a first node and at least one second node through a network of buses and at least one router which is arranged on any of the buses. The data to be transmitted includes performance-ensuring data which guarantees at least one of throughput and a permitted time delay. The first node includes: a packet generator configured to generate a plurality of packets, each of which includes the data to be transmitted and classification information that indicates the class of the data to be transmitted to be determined according to its required performance; and a transmission controller configured to control transmission of the packets. The at least one router includes: a buffer section configured to store the received packets separately after having classified the packets according to their required performance by reference to the classification information; and a relay controller configured to control transmission of the packets that are stored in the buffer section at a transmission rate which is equal to or higher than the sum of transmission rates to be guaranteed for every first node associated with the classification information by reference to each piece of the classification information.

In one embodiment, the at least one router includes a plurality of routers. The plurality of routers operate at the same operating frequency, and the respective relay controllers provided for those routers control transmission of the packets at the same transmission rate. And the same transmission rate is set to be equal to or higher than the maximum one of the transmission rates to be guaranteed by the plurality of routers.

In another embodiment, a transmission rate to be guaranteed has been set in advance with respect to each performance-ensuring data. The transmission controller controls transmission of packets of the performance-ensuring data either at a predetermined rate which exceeds a transmission rate to be guaranteed by the performance-ensuring data or without imposing a limit to the transmission rate. The at least one router is able to transmit the packets of the performance-ensuring data at a rate exceeding the transmission rate to be guaranteed by using a first band in which the transmission rate to be guaranteed is able to be maintained and a second band which is an extra band. The relay controller classifies, by reference to the classification information, the respective packets of the performance-ensuring data among the plurality of packets that are stored in the buffer section into packets to be transmitted using the first band and packets to be transmitted using the first and second bands, and transmits preferentially the packets to be transmitted using the first band.

In another embodiment, the data to be transmitted further includes non-performance-ensuring data which guarantees neither throughput nor permitted time delay. The transmission controller controls transmission of packets of the non-performance-ensuring data without imposing a limit to their transmission rate. The buffer section stores the received packets of the non-performance-ensuring data separately. And the relay controller transmits the packets of the performance-ensuring data and the packets of the non-performance-ensuring data in this order.

In another embodiment, the packet generator further gives time information about the deadlines of the packets to the packets, and as for packets to which the same piece of classification information is given, the relay controller determines the order of transmission of the packets according to their deadlines.

In another embodiment, the time information about the deadlines is information about a deadline by which the packets are supposed to arrive at the at least one second node, information about a time when the first node transmitted the packets, information about an accumulated value of processing times by the first node and the router, or information about the value of a transmission counter indicating the order of transmission of the packets from the first node.

In another embodiment, if the time information about the deadlines does indicate the deadlines, the relay controller transmits packets with closer deadlines more preferentially than the other packets.

In another embodiment, as for each of the packets to be transmitted using the first and second bands, the relay controller and the transmission controller determine a rate exceeding a transmission rate to be guaranteed based on the processing ability of a node or link that is going to cause a bottleneck for the bus system.

In another embodiment, the performance-ensuring data includes burst data with a burst property and non-burst data with no burst property. The classification information given by the packet generator is able to distinguish the burst data from the non-burst data. The buffer section of the at least one router stores the burst data and the non-burst data in the multiple buffers separately. And the relay controller of the at least one router transmits the packets of the burst data and then the packets of the non-burst data.

In another embodiment, the transmission controller of the first node transmits the burst data at a predetermined transmission rate, and the relay controller transmits at least the burst data at a predetermined transmission rate.

In another embodiment, the at least one second node includes a plurality of second nodes, and the buffer section of the at least one router stores the packets of the respective second nodes in the plurality of buffers separately from each other.

In another embodiment, the packets include command-sending packets and data-sending packets, and the relay controller transmits the command-sending packets without imposing any limit to their transmission rate.

In another embodiment, the packets include command-sending packets and data-sending packets, and the buffer section of the at least one router stores the command-sending packets and the data-sending packets in the plurality of buffers separately from each other.

In another embodiment, the packet generator of the first node multiplexes the packets and transmits a resultant multiplexed packet.

In another embodiment, the first node that transmits the multiplexed packet and the at least one router include a signal line to transmit information indicating division positions at which the multiplexed packet is restored to respective data.

A router according to another embodiment of the present invention is arranged on any of buses that form a network in a bus system for a semiconductor circuit to relay data to be transmitted between a first node and at least one second node of the bus system. The first node generates and transmits a plurality of packets, each of which includes the data to be transmitted and classification information that indicates the class of the data to be transmitted to be determined according to its required performance. The data to be transmitted includes performance-ensuring data which guarantees at least one of throughput and a permitted time delay. And the router includes: a buffer section which stores the received packets separately after having classified the packets according to their required performance by reference to the classification information; and a relay controller which controls transmission of the packets that are stored in the buffer section at a transmission rate which is equal to or higher than the sum of transmission rates to be guaranteed for every first node associated with the classification information by reference to each piece of the classification information.

Hereinafter, a router as an embodiment of the present invention will be described with reference to the accompanying drawings.

What will be described in the following description is a technique for increasing the transmission efficiency of distributed buses (NoC) in a semiconductor integrated circuit at as low a bus' operating frequency as possible based on quantitative tentative calculations while minimizing mutual interference between multiple traffic flows running through the buses with mutually different required performances. What will also be described in the following description is a configuration for a router that ensures performance (in terms of throughput and permitted time delay) for use in the NoC and the QoS (Quality of Service) of the distributed buses.

The present inventors set “classes”, into any of which a given traffic flow is to be grouped according to its required performance. That is to say, a traffic flow running out of a bus master as an output node is grouped into any of those classes that have been set and a buffer to store the traffic flow is provided separately in a router for each of those classes in order to reduce interference between the classes. For example, in this description, roughly two major classes, namely, a performance-ensured class and a non-performance-ensured class, are set. And each of these classes may be subdivided into sub-classes according to its required performance. It will be described in further detail later with respect to exemplary embodiments how to set such classes and sub-classes.

In one embodiment of the present invention, with respect to a traffic flow of the performance-ensured class, on which a relatively strict performance requirement is imposed, routers and bus masters perform transmission processing at a high priority level and at a controlled rate. On the other hand, a traffic flow of the performance-ensured class, on which a less strict performance requirement is imposed, and a traffic flow of the non-performance-ensured class, on which no performance requirement is imposed at all, are transmitted at a low priority level but at a rate exceeding the requested band. As a result, the traffic flow of the performance-ensured class can definitely have its performance ensured. On the other hand, the traffic flow of the performance-ensured class with less strict performance requirement and the traffic flow of the non-performance-ensured class can be transmitted using the bus' extra band to be produced by worst estimation. By reducing the interference between those classes of performance requirement and using the bus more efficiently, there is no need to overestimate the required bus bandwidth to ensure the performance, and a performance-ensured bus can be established at a low bus' operating frequency. On top of that, since the bus' operating frequency can be decreased, the power dissipation by the bus and the required chip area can be both reduced, the flexibility of layout can be increased, and the restriction of bus lines (e.g., distance of bus lines to be wired) can be relaxed.

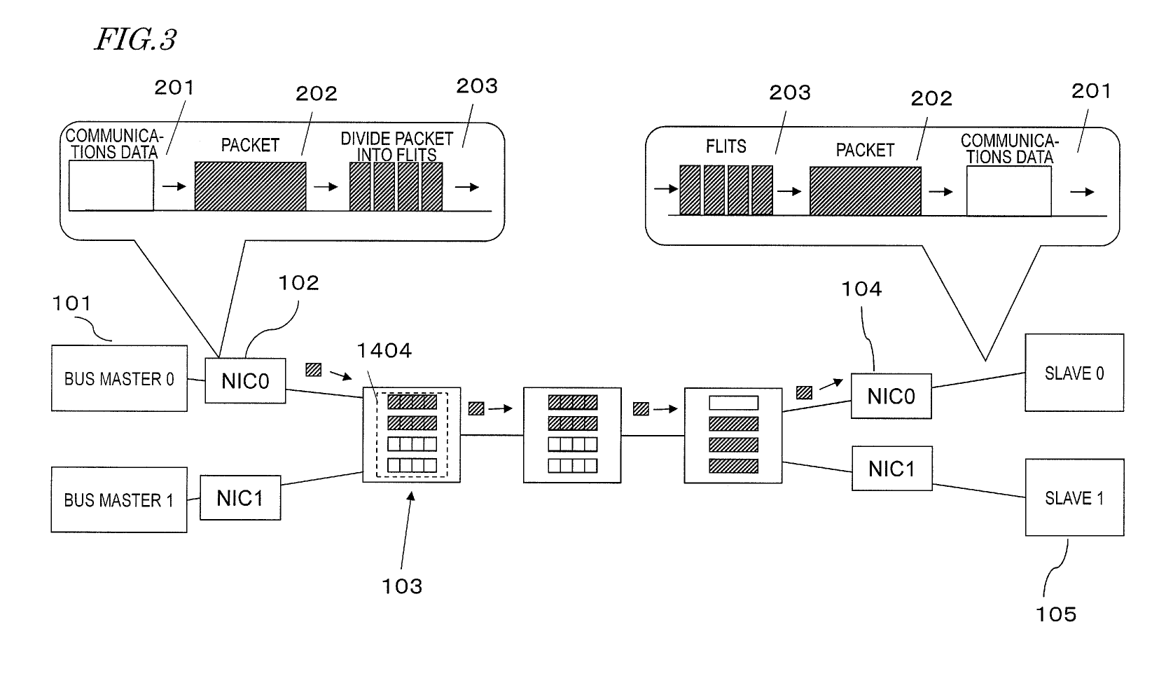

FIG. 2 shows a processing policy according to this embodiment to be applied to the performance-ensured class and the non-performance-ensured class.

Suppose Performance-Ensured Classes A, B and C and Non-Performance-Ensured Class Z have been defined as traffic flow classes as shown in FIG. 2.

As for traffic flows of Classes A and B, routers and bus masters set a transmission rate (upper limit value) based on the requested bandwidth and control the transmission rate of the traffic flows, thereby ensuring their performance. In particular, a traffic flow of Class A needs to satisfy a more strict performance requirement than a traffic flow of Class B does, and therefore, is transmitted at a higher priority level.

A traffic flow of Class C is transmitted by routers and bus masters at a transmission rate exceeding the requested band. As a result, the bus' extra band can be used with the performance ensured.

A traffic flow of Class Z is processed at a lower priority level than a traffic flow of any of the other classes described above. In this case, non-performance-ensuring data can be transmitted without putting an upper limit to the transmission rate and the bus' extra band can be used. In addition, the routers can group the buffers into the respective classes, can reduce the interference between the classes by performing the transmission control on a class-by-class basis, and can transmit a traffic flow with a high priority level at a shorter time delay. As a result, the bus can be used more efficiently with the performance ensured at a lower bus' operating frequency.

In this description, the “worst estimation” refers herein to calculating the bus bandwidth at which the performance can be ensured by expecting, during the design process, the traffic flow status when the bus system is in the worst-case scenario. Actually, however, the traffic flow rate may sometimes be lower than in the worst-case scenario, and there will be an extra band, i.e., a margin, in the bus.

<Overall Configuration>

FIG. 3 illustrates an exemplary NoC which is implemented using routers 103 as an embodiment of the present invention. In FIG. 3, illustrated are an exemplary buffer configuration for the routers 103 and how a packet may be transmitted.

This NoC includes a bus master 101, a master network interface controller (NIC) 102, at least one router (such as the router 103), a slave NIC 104, and a slave 105.

The bus master 101 (which will be sometimes simply referred to herein as a “master”) is connected to the master NIC 102. The master and slave NICs 102 and 104 are connected together via the at least one router (such as the router 103). The slave NIC 104 is connected to the slave 105. In the following description, each of the routers is supposed to have the same configuration and perform the same operation. Thus, the router 103 will be described as an example of the at least one router.

The router 103 includes an input buffer section 1404 to store the packets 202. Specifically, the input buffer section 1404 stores the packets 202 on a class-by-class basis according to the class of each of those packets 202 to relay. The router 103 includes such an input buffer section 1404, and therefore, can arrange the order of priorities of the packets 202 to transmit as will be described in detail later. Also, since the master NIC 102 and the router 103 transmit the packets at rates that have been set in advance for the respective classes, each of the NIC 102 and router 103 includes a rate controller (to be described later).

The master NIC 102 generates one or more packets 202 based on the communication data 201 received from the bus master 101, divides the packet 202 into data units, of which the size is small enough to send it in one cycle of the bus' operating frequency, and transmits those data units. In this description, such data units, of which the size is small enough to send them in one cycle of the bus' operating frequency, will be referred to herein as “flits”. In FIG. 3, illustrated are a number of such flits 203.

The packet to be transmitted is stored in the input buffer section 1404 of the router 103, is sent on a flit-by-flit basis from the router 103 and other routers, and then arrives at the slave NIC 104. In response, the slave NIC 104 reconstructs each packet based on those flits 203 received, restores the original communication data based on a plurality of packets, and transmits the original communication data to the slave 105.

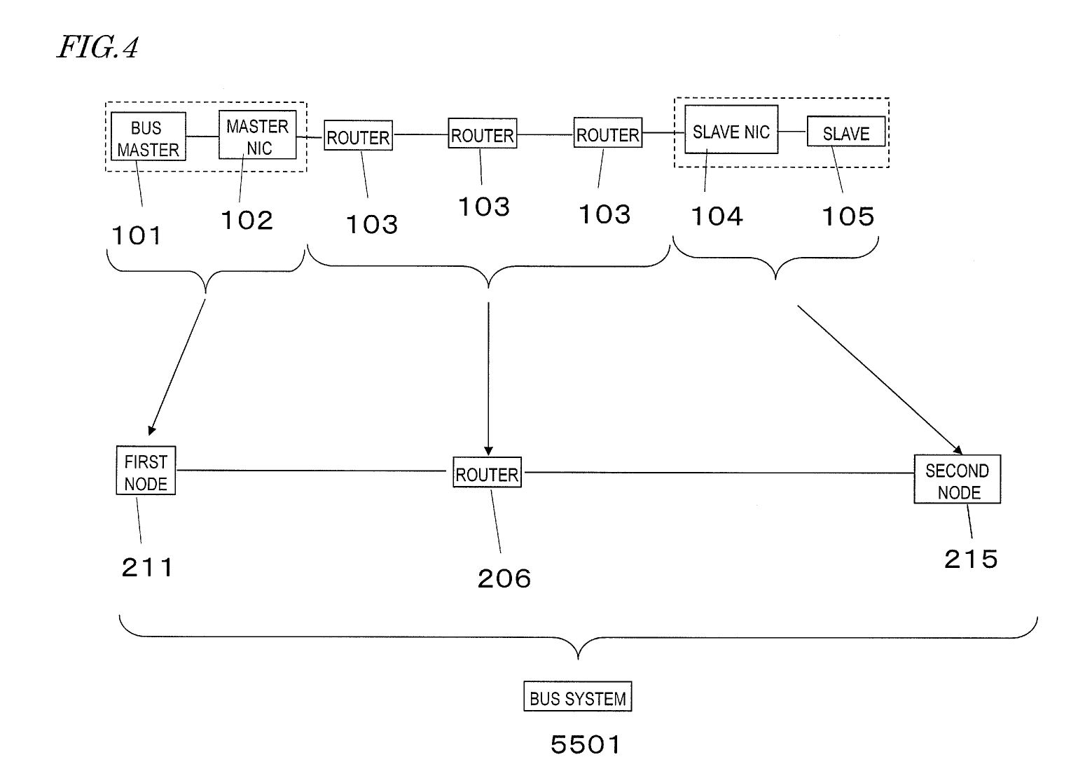

FIG. 4 shows the concepts of respective components of an NoC.

In this description, some of these components will be collectively referred to as follows.

The bus master 101 and the master NIC 102 will be collectively referred to herein as a “first node 211”.

The slave 105 and the slave NIC 104 will be collectively referred to herein as a “second node 215”.

More than one router 103 will be regarded herein as a single router macroscopically, and will be referred to herein as a “router 206”.

And the first and second nodes 211 and 215 and the entire router 206 will be collectively referred to herein as a “bus system 5501”.

Hereinafter, a router 206 according to an exemplary embodiment of the present invention will be described with reference to the accompanying drawings.

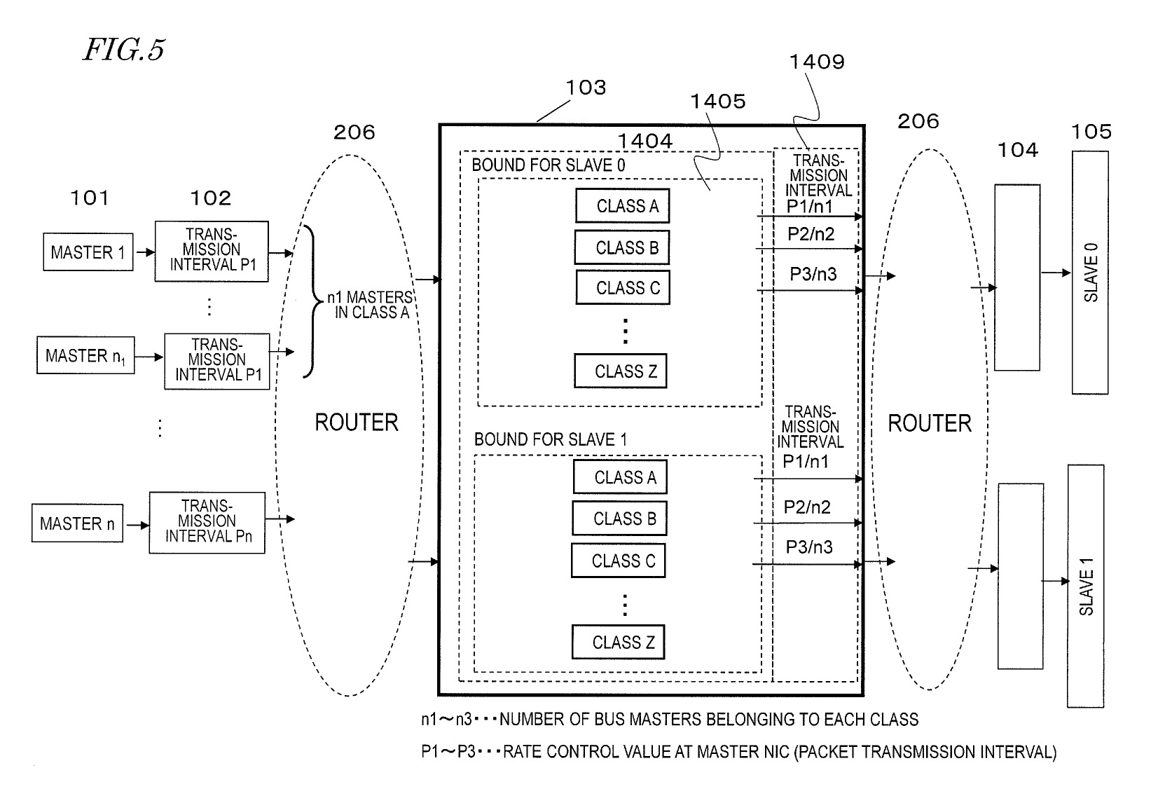

FIG. 5 schematically illustrates a configuration for the NoC shown in FIG. 3.

First of all, the master NIC 102 receives data about each traffic flow in the input buffer section (not shown) from the master 101 and transmits the packets 202 at a transmission rate which has been set for each master 101 to be high enough to satisfy the performance requirement on each traffic flow.

The router 103 includes an input buffer section 1404 and a rate controller 1409.

The input buffer section 1404 (will be simply referred to herein as a “buffer section”) includes input buffers 1405, which store traffic flows that have been grouped according to their destinations and their classes. In the example illustrated in FIG. 5, each of those input buffers 1405 is implemented as an FIFO (First In, First Out) buffer. By being provided with such an input buffer section 1404, the router 103 can change the traffic flows to transmit so as to prevent a traffic flow of a high priority level class from being affected by a traffic flow of a low priority level class. Even though the buffer is supposed to be an input buffer in this embodiment, this configuration is also applicable in the same way, even if the buffer is included as an output buffer. The reason is that the packets just need to be stored separately according to the performance requirement and the rate of transmission of the packets to an adjacent router or slave NIC just needs to be controlled, no matter where the buffers are arranged.

The rate controller 1409 transmits the packets at a transmission rate that has been set on a class-by-class basis. For example, the rate controller 1409 may set the transmission rate in the form of a transmission interval. In this description, the rate controller will be sometimes referred to herein as a “relay controller”.

As the transmission rate set by the rate controller 1409 of the router 103, a transmission rate value which is equal to or greater than the transmission rate guaranteed for the master NIC 102 needs to be set on a class-by-class basis, because the packets issued by a plurality of masters are confluent there. For example, if there are N masters that have been grouped into the same class and if the transmission rate is set at a predetermined transmission interval, the transmission interval is set to be equal to or smaller than the value obtained by dividing the transmission interval of the master NIC by N. That is to say, the packets are transmitted at a transmission rate that is equal to or greater than the sum of the transmission rates to be guaranteed by the respective masters. Optionally, if such a rate control is performed in the routers, not just in the master NICs, the time delay and throughput of each class can be guaranteed end-to-end.

Specifically, as a method for getting the transmission rate set by a router, an individual transmission rate value may be set for each router based on the rate to be guaranteed for the traffic flow running through that router.

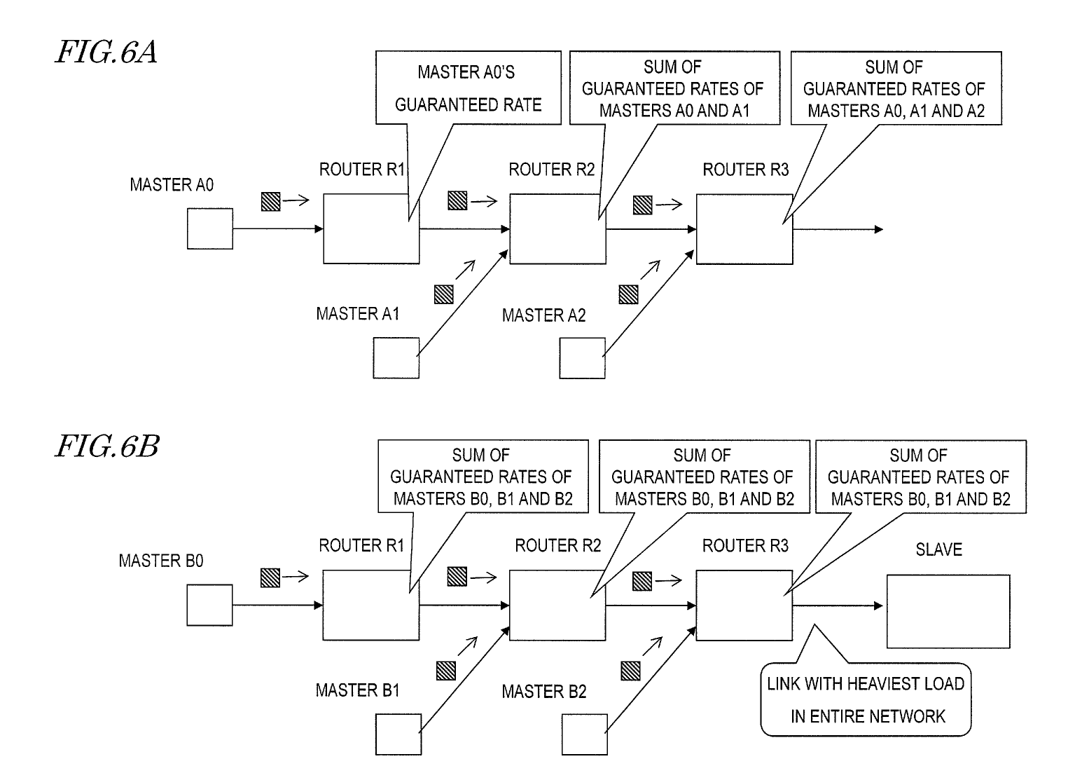

FIGS. 6A and 6B show exemplary transmission rate values to be set for respective routers.

FIG. 6A illustrates an example in which a minimum guaranteed transmission rate value is set based on the traffic flows running through the respective routers. For example, as shown in FIG. 6A, the sum of the transmission rates to be guaranteed for the respective traffic flows coming from the masters A0 and A1 is set to be the traffic flow transmission rate for the router R2 and controlled. If the transmission rates of the respective routers are set by such a method, the bus operating frequencies of the respective routers can be minimized. However, the implementation cost will rise, because the respective routers should be designed to have the best frequencies.

According to another exemplary embodiment, the same transmission rate value may also be set for the respective routers. In that case, the traffic flow transmission rates of the respective routers may be set, with respect to each class, to be the transmission rate of a router where traffic flows to be guaranteed are confluent with each other most heavily in the overall system, and controlled.

For example, as shown in FIG. 6B, the router R2 sets the traffic flow transmission rate of each router based on the transmission rate value (i.e., the sum of the rates guaranteed for the masters B0, B1 and B2) of the router R3 where traffic flows are confluent with each other most heavily. By setting the transmission rate that is the highest in the entire system to be the transmission rate of each router, a bottleneck will be hardly created in the entire network. Consequently, the performance can be ensured more easily and the hardware can be laid out more easily, because the bus system can be designed at a single operating frequency.

In this exemplary embodiment, the highest transmission rate in the entire system is supposed to be set in common to be the transmission rate at the relay controller of each router. However, this is just an example. Alternatively, the transmission rate may even be set to be higher than the highest transmission rate in the entire system.

Nevertheless, if every router were operating at the same operating frequency and if the transmission rate were set to be the same in every relay controller, an excessively high transmission rate would be set for some routers. In that case, those routers should operate at a more than necessarily high operating frequency.

It should be noted that if the operating frequency that makes the routers operate at the sum of the respective transmission rates to be guaranteed is excessively high, then not every router has to be driven at the same operating frequency. Alternatively, as in a system bus or a local bus, the operating frequency may be changed on a bus role basis, a router with the highest transmission rate may be selected, and the transmission rate may be set. In this manner, it is possible to prevent the operating frequency of a router on a local bus which is relatively close to a master from going excessively high.

The classes in the input buffer section 1404 may be grouped into a time-delay-guaranteed class which needs to take the time delay into consideration and a non-time-delay-guaranteed class which does not have to take the time delay into consideration. The time-delay-guaranteed class is subdivided into Class A with a burst property and Class B with any other property. In this embodiment, the input buffers are allocated according to those subdivided low-order classes.

As for the low-order classes of the time-delay-guaranteed class and the non-time-delay-guaranteed class, any arbitrary number of input buffers may be allocated to any arbitrary number of classes.

In this embodiment, the “time-delay-guaranteed class” is supposed to be subdivided based on a permitted time delay. However, the “time-delay-guaranteed class” may also be subdivided based on throughput, not on time delay. That is to say, according to this embodiment, the time-delay-guaranteed class may be subdivided based on at least one of time delay and throughput.

The input buffer section 1404 of the router 103 and the input buffer section (not shown) of the master NIC 102 are configured so that buffers are separated according to their destinations. By separating the buffers not only on a class-by-class basis but also according to their destinations, interference between traffic flows with mutually different destinations can be reduced. Also, even if the bus is congested with traffic flows bound for a certain destination, traffic flows bound for another destination can secure buffers for sure, and can be transmitted just as intended.

In addition, if the buffers are separated as described above, interference between traffic flows with mutually different priority levels and interference between traffic flows with mutually different destinations can be reduced by changing the transmission rate according to the class and the destination in a situation where those buffers are implemented as FIFOs. Nevertheless, if the transmission rate can be changed and if the buffers to use can be managed on a class-by-class basis or on a destination basis by using randomly accessible memories, for example, then those buffers do not have to be physically separated from each other.

For example, not only randomly accessible memories but also an address table as data may be provided for the router 103. The address table is a table with which the storage addresses and stored packets are managed on a destination slave basis for each class in the memory. By using those memories and such an address table, any arbitrary packet stored in the input buffer of the router 103 can be freely read from and written to. As a result, effects to be obtained by logically separating the buffers can be achieved. Even if packets with low priority levels or bound for a certain destination are stored in a buffer, packets with high priority levels or bound for another destination can be transmitted without interfering with the former packets.

Still alternatively, the bus system may also be configured so that buffers to be used by a traffic flow with a low priority level are usable for a traffic flow with a high priority level. In that case, the buffers usable for the traffic flow with the high priority level will include both buffers not to be interfered with by the traffic flow with the low priority level and buffers to be interfered with by the traffic flow with the low priority level. However, just at least one buffer not to be interfered with by the traffic flow with the low priority level needs to be secured. In that case, interference by the traffic flow with the low priority level can be reduced.

Furthermore, as a method for controlling the transmission rate between the rate controller 1409 of the router 103 and the rate controller (not shown) of the master NIC 102, the packet transmission interval is controlled according to this embodiment, because such a method can be implemented easily. For example, if a traffic flow needs to be transmitted at a higher transmission rate, the transmission rate can be increased by setting the transmission interval to be a narrower one. Specifically, if the traffic flow transmission rate needs to be doubled, then the transmission interval may be halved. On the other hand, if the traffic flow transmission rate needs to be halved, then the transmission interval may be doubled. However, the transmission rate may also be controlled by any other method such as a technique for measuring the size or length of data that has been transmitted per unit time or in a unit cycle. Furthermore, even though the slave is generally implemented as a memory or a memory controller, the slave does not have to be a memory but may also be any other arbitrary node such as a master, an I/O or a router.

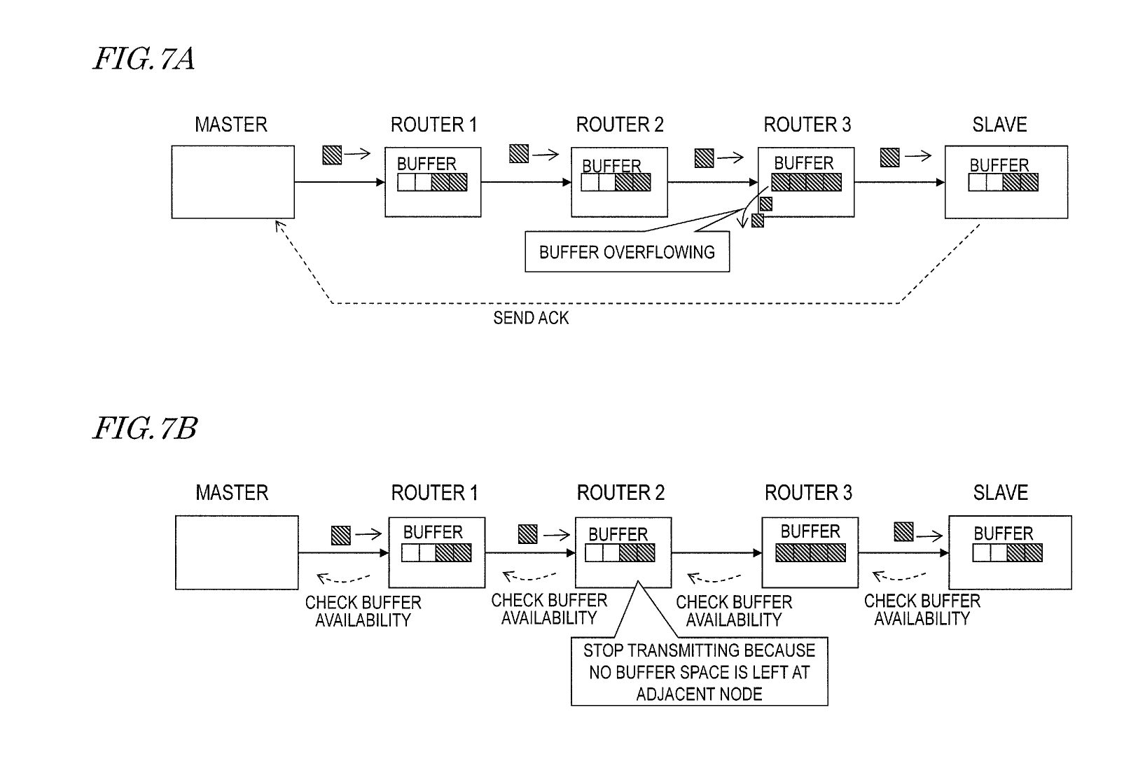

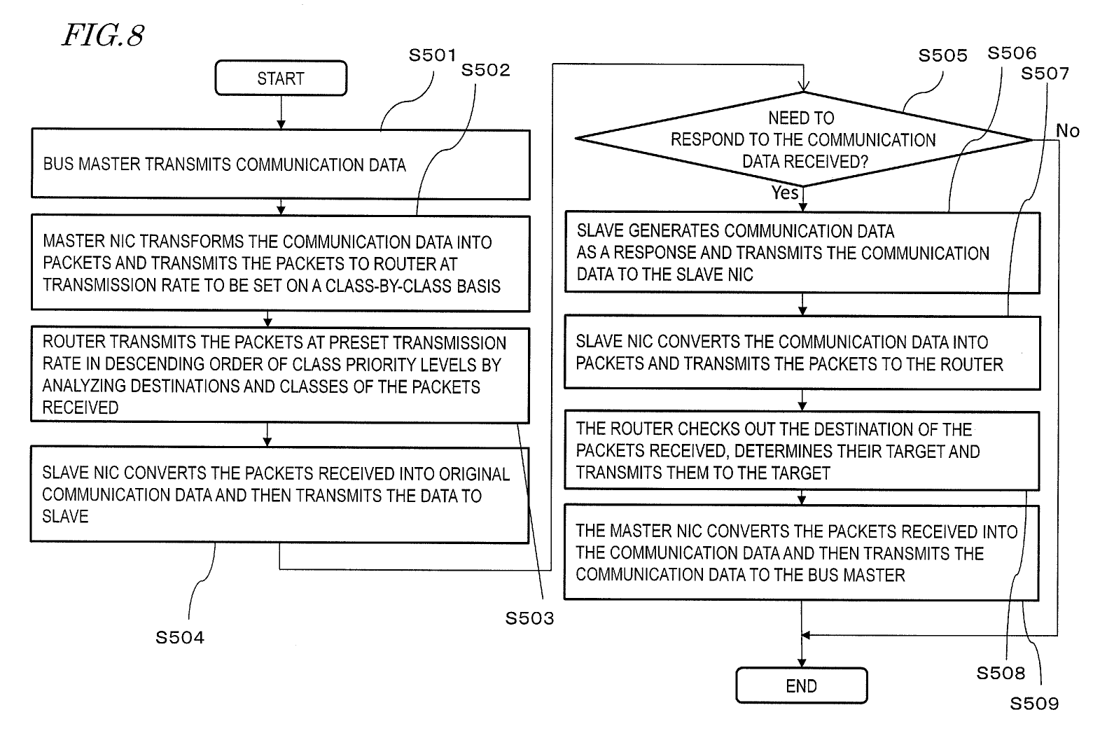

The flow control to be carried out by the router 103 of this embodiment is quite different from a flow control to be applied to the Internet. Hereinafter, the reason will be described with reference to FIGS. 7A and 7B.

FIGS. 7A and 7B shows how the effect achieved varies depending on whether the configuration of the router 103 described above is applied to the Internet or to a semiconductor bus system.

On the Internet (as shown in FIG. 7A), the flow control of data transmitted from a master is carried out based on the exchange between the master and a slave compliant with the TCP (Transmission Control Protocol). Meanwhile, each router on the transmission route performs a routing control for determining the transmission route or the QoS control. However, no routers on the Internet carry out any flow control. Instead, since data is just transmitted through the Internet, no matter how much space is left in a buffer at an adjacent node, data could be lost due to buffer overflowing.

In the example illustrated in FIG. 7A, each of Routers 1 and 2 and Slave, of which the buffer still has a space left, can receive data that has been transmitted from the adjacent node. On the other hand, Router 3, of which the buffer has no space left, cannot store the data in its buffer and causes buffer overflowing. In addition, even if packets are discarded on the router end in order to avoid convergence before the buffer overflows, data could be lost, too.

On the other hand, in the semiconductor bus system to which this embodiment is applied (see FIG. 7B), the flow control is carried out between every pair of nodes on the transmission route. Specifically, for that purpose, before sending data, each node sees if there is any space left in the buffer of the adjacent destination node. And the node transmits the data only if there is still a space left in the buffer.

That is why by stopping transmitting the data if there is no space left in the buffer at the destination node, buffer overflowing can be avoided. In the example illustrated in FIG. 7B, only Master and Routers 1 and 3 which have confirmed that there is still a space left in the buffer at the adjacent destination node (which may also be a router) transmit data, while Router 2 which has failed to confirm that there is a space left in the buffer at the adjacent destination node stops transmitting the data. As a result, the data loss due to buffer overflowing can be avoided. As can be seen, the semiconductor bus system to which this embodiment is applied is quite different from the Internet technology in the respect that no data is supposed to be lost on the transmission route.

If the disclosure of the embodiments described above were applied to the Internet, then excessive amounts of data would be sent on a non-rate-controlled traffic flow or on a traffic flow to be transmitted at a rate exceeding the requested bandwidth to cause buffer overflowing and packet loss on the route. On sensing that packet loss, the transmission node would retransmit the data with the data size cut down dynamically. Consequently, in that case, it should be difficult to maximize the efficiency to use the extra band and to ensure the performance in terms of time delay and throughput.

On the other hand, the semiconductor bus system described above does not lose, but accumulates, the excessive amounts of data that has been transmitted. That is why each router can transmit low priority level data that has been accumulated in the buffer by taking advantage of a time interval in which no high priority level data is being transmitted, and therefore, can use the bus more efficiently. Each router will have such a time interval in which no high priority level data is being transmitted and in which there is a margin in the bus band. The router of this embodiment can make data flow by using that extra band as will be described later.

<General Flow>

FIG. 8 is a flowchart showing the procedure of operation of an NoC including routers according to an embodiment of the present invention.

The bus master 101 transmits communication data 201 to the master NIC 102 (in Step S501). In response, the master NIC 102 transforms the communication data 201 received into packets 202 and transmits the packets 202 to the router 103 at a transmission rate to be set on a class-by-class basis (in Step S502).

The master NIC 102 sets the transmission rates of time-delay-guaranteed classes A and B to be a transmission rate at which the performance required by each of these classes in terms of the requested bandwidth and time delay is satisfied. As for the transmission rate of Class C, on the other hand, the master NIC 102 may or may not set the transmission rate to be an upper limit value exceeding the requested bandwidth in order to use the extra band while ensuring the performance in terms of requested bandwidth and delay.

And as for the transmission rate of the non-time-delay-guaranteed class (i.e., Class Z), the master NIC 102 does not put an upper limit to the transmission rate in order to use the extra band. It should be noted that the transmission priority levels of these four classes are supposed to decrease in the order of Classes A, B, C and Z. That is to say, Class A is processed at the highest priority level. FIG. 2 shows a difference in priority level and a difference in rate control between the performance ensured classes A, B and C and the non-performance ensured class Z.

The more than one router 103 transmits the packets at a preset rate value in the descending order of the class priority levels according to the destination slave IDs and classes of the packets 202 received (in Step S503).

The slave NIC 104 converts the packets 202 received from the router 103 into the original communication data 201 and then transmits the communication data to the slave 105 (in Step S504). In response, the slave 105 interprets the communication data 201 received to determine whether or not the slave 105 needs to respond to the communication data 201 received (in Step S505). If the answer is YES, the slave 105 generates communication data as a response and transmits the communication data to the slave NIC 104 (in Step S506). The slave NIC 104 converts the communication data 201 which has been received as a response from the slave into packets 202 and transmits the packets 202 to the router 103 (in Step S507). The router 103 checks out the destination of the packets 202 received, determines their target and transmits them to the target (in Step S508). Meanwhile, the master NIC 102 converts the packets 202 received into the communication data 201 and then transmits the communication data 201 to the bus master 101 (in Step S509).

FIG. 9 shows the rule of classifying bus masters so that the performance-ensuring data and the non-performance-ensuring data can be distinguished from each other, to say the least, in order to lower the estimated bus' operating frequency required. The designer of a bus system sets the class of a given bus master according to this classification rule. Although this is not an operation to be performed by a router, it will be described anyway in the following description.

In order to classify respective masters in advance, first of all, the designer defines the specification required for a traffic flow generated by every master during the design process (in Step S3201).

The designer groups a master which has a low priority level and which just needs to make a traffic flow run only when the bus is not occupied into Class Z (in Step S3202). Such a master grouped into Class Z generates a non-performance-ensured traffic flow, which may be data output from a processor, for example.

The designer groups a master which needs to transfer data at a rate exceeding the requested bandwidth into Class C (in Step S3205), to which masters in charge of some processor- or graphics-related processing belong. Class C further includes a master that outputs a traffic flow which should be transmitted at rates that vary with time but that are always equal to or higher than a certain rate as in filter processing, for example, and which may be transmitted as a preceding flow at a rate that is equal to or higher than an average requested bandwidth time wise.

The designer groups a master which belongs to the time-delay-guaranteed class, on which a strict requirement is imposed in terms of requested bandwidth and permitted time delay, and which has a burst property into Class A (in Step S3203). A traffic flow generated by such a master in Class A is subjected to transmission processing most preferentially, and therefore, is transmitted by a router without interfering with a traffic flow in any other class. Consequently, the performance of each traffic flow can be ensured in terms of time delay and throughput at an even lower bus' operating frequency.

The designer groups the other masters into Class B (in Step S3204).

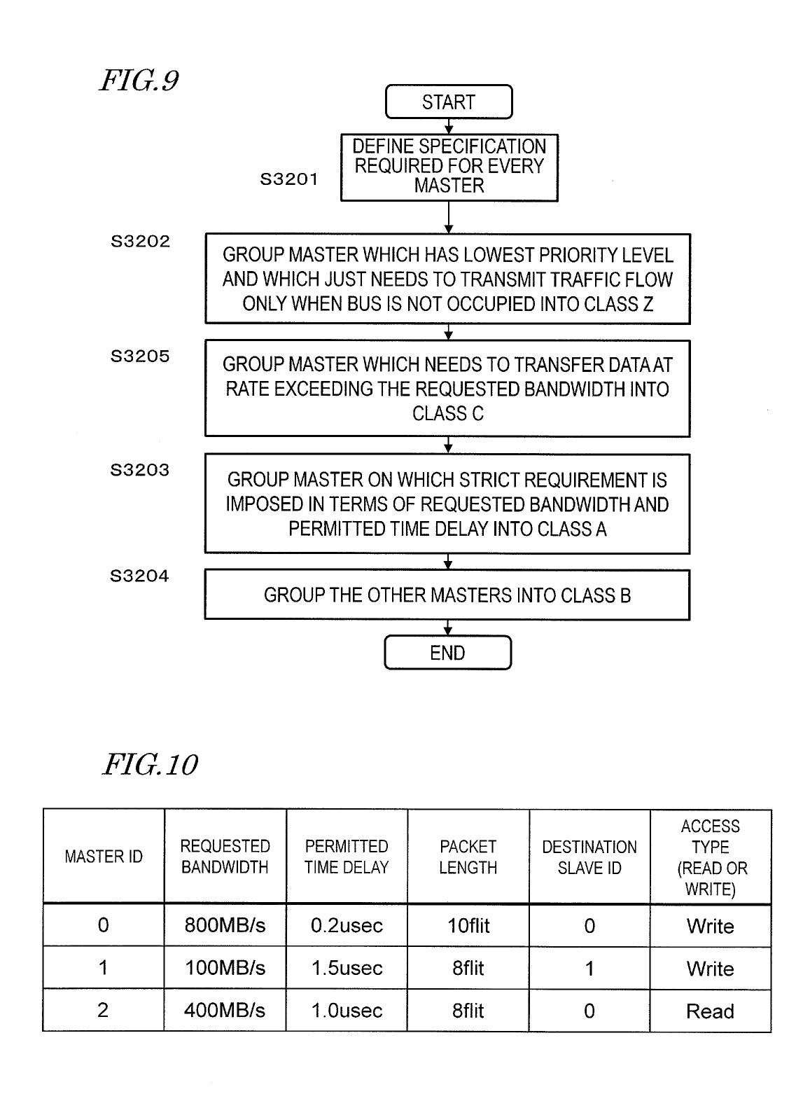

FIG. 10 shows specific exemplary definitions of specifications required for traffic flows to be generated by masters.

The required specifications are defined by various parameters. Examples of those parameters include a master ID, a traffic flow requested bandwidth, a permitted time delay, the length of a packet when generated, and a destination slave ID. If the slave is a memory, the type of the communication data, which may be Read access or Write access, for example, is also defined. For example, the item on the second row of the table shown in FIG. 10 indicates the attributes of a traffic flow generated by a master of which the master ID is 0. This traffic flow has a requested bandwidth of 800 megabytes per second (MB/s), a permitted time delay of 0.2 μs and one packet length of 10 flits, and is a Write access with respect to a slave of which the slave ID is 0.

<Respective Components>

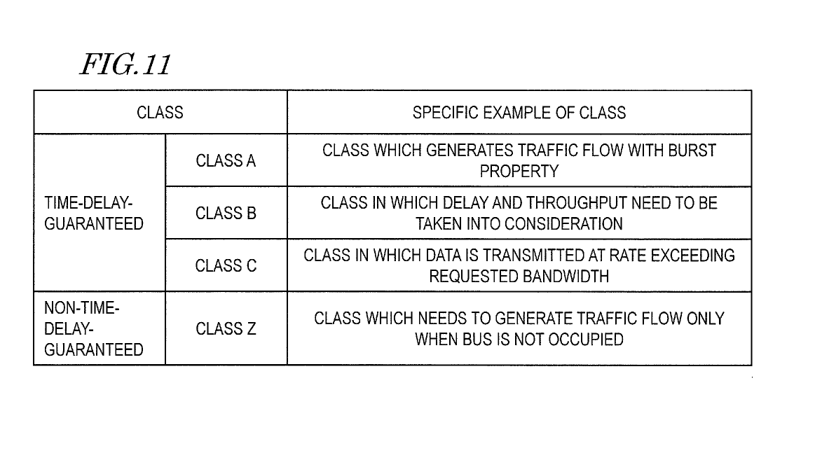

FIG. 11 shows respective classes to which the bus masters 101 are grouped and their specific examples. In this embodiment, once a bus master 101 is determined, its class is supposed to be determined automatically. However, if a certain bus master performs multiple kinds of processing and sends a traffic flow, the class may be determined on a traffic flow basis.

One of the following two methods may be adopted as a method for defining classes on a traffic flow basis.

For example, the classes may be defined on a traffic flow basis by having a bus master add class specifying information to data that forms a traffic flow and send such data to a master NIC. As described above, the specification required for a traffic flow to be generated by each bus master is defined by the designer. The bus master naturally knows the specifications required for a traffic flow and therefore can specify the class.

Alternatively, the master NIC may define the classes on a traffic flow basis. The master NIC stores, in a memory in advance, a table (not shown) in which the identifier of each traffic flow is associated with a class. A bus master adds an identifier associated with the specifications required for a traffic flow to the data that forms the traffic flow and then sends the data to the master NIC. In response, the master NIC can determine the class of that traffic flow by reference to the table with the identifier of the traffic flow received.

According to this embodiment, the bus masters 101 are grouped into respective classes following the classification rule shown in FIG. 9. Specifically, the classes are grouped into time-delay-guaranteed classes (i.e., Classes A, B and C) in which the time delay needs to be taken into consideration and a non-time-delay-guaranteed class (i.e., Class Z) in which the permitted time delay is so long that the time delay can be guaranteed even without taking the delay into consideration.

The time delay guaranteed class is subdivided into a class in which a traffic flow is transmitted at a rate exceeding the requested bandwidth (i.e., Class C), a class which generates a traffic flow with a burst property and of which the permitted time delay is particularly short or the requested bandwidth is particularly broad (i.e., Class A), and the other class in which delay and throughput need to be taken into consideration (i.e., Class B).

For example, masters such as encoders and decoders which need to transmit a huge size of data in a short period are grouped into Class A, masters such as peripherals and I/Os are grouped into Class B, and masters in charge of some processor- or graphics-related processing, involving a data transfer of which the performance needs to be ensured, are grouped into Class C.

Into the non-time-delay-guaranteed class (i.e., Class Z), grouped is a master that generates a traffic flow for which the performance does not have to be ensured in terms of throughput and time delay and which has a low priority level and may just need to be transmitted only when the bus is not occupied. Naturally, the classes may also be grouped on a traffic flow basis as described above. For example, a traffic flow for graphics related processing, for which the performance does not have to be ensured, and a traffic flow including the output data of a processor are grouped into Class Z. It should be noted that if the processor or graphics related traffic flow includes data for which the performance needs to be guaranteed in terms of time delay or throughput, such a traffic flow may also be grouped into a performance-ensured class, instead of Class Z.

Optionally, a class with an even higher priority level may be provided for a traffic flow or master for which a particularly strict performance requirement (on a permitted time delay or a requested bandwidth) is imposed among other classes, and such a traffic flow or master may be grouped into such a class.

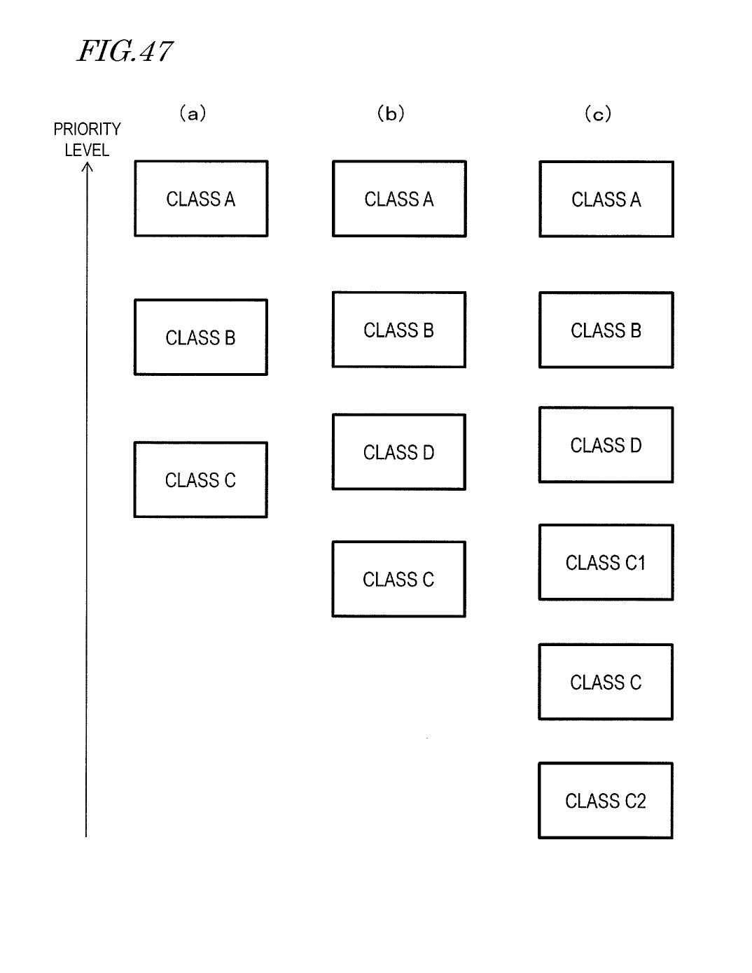

Portions (a), (b) and (a) of FIG. 47 illustrate how classification may be done according to the priority level of a time-delay-guaranteed class. In FIG. 47, the closer to the top of the paper a class is located, the higher the priority level of that class is. In each of these portions (a), (b) and (c) of FIG. 47, classification is supposed to be done independently of each other. It should be noted that there is no correspondence in priority level between these portions (a), (b) and (c) of FIG. 47.

Portion (a) of FIG. 47 illustrates an exemplary set of priority levels for Classes A, B and C as described above. As far as the priority level is concerned, Class A has the highest priority level, and the priority level decreases in the order of Classes B and C.

In another example, to shorten the time delay to be caused by some processor related traffic flow belonging to Class C, another high-priority-level class D may be provided for such a traffic flow, separately from the other traffic flows belonging to the same Class C. Portion (b) of FIG. 47 illustrates such Class D, of which the priority level is lower than that of Class B but higher than that of Class C. Some processor related traffic flow is grouped into such Class D. In order to shorten the time delay, at least a traffic flow with a requested bandwidth that has been set with respect to Class D is transmitted at a higher priority level than a traffic flow belonging to Class C.

In still another example, traffic flows to be grouped into Class D described above may also be grouped into subdivided classes. Portion (c) of FIG. 47 illustrates exemplary classes which have been subdivided with a traffic flow to be transmitted at a rate exceeding the requested bandwidth taken into consideration. In this example, Classes A, B, D, C1, C and C2 have been set in the descending order of priorities.

First of all, among traffic flows to be grouped into Class D, a class to which traffic flows exceeding the requested bandwidth belong is set to be Class C1. As a result, those traffic flows exceeding the requested bandwidth are transmitted at a higher priority level than traffic flows also exceeding the requested bandwidth but belonging to Class C.

Alternatively, among traffic flows to be grouped into Class D, a class to which traffic flows exceeding the requested bandwidth belong may also be set to be Class C2. As a result, those traffic flows exceeding the requested bandwidth are transmitted at a lower priority level than traffic flows belonging to Class C.

If all of those traffic flows that have been grouped into Class D at first need to be transmitted at as high a priority level as possible, the time delay to be caused by a traffic flow belonging to Class D may be set to be shorter than what is caused by a traffic flow belonging to Class C. On the other hand, if those traffic flows exceeding the bandwidth requested for Class D need to be transmitted at a low priority level, those traffic flows exceeding the requested bandwidth may be grouped into Class C2, and the time delay to be caused by a traffic flow belonging to Class C2 may be shorter than what is caused by a traffic flow belonging to Class C.

Optionally, in order to transmit a traffic flow belonging to Class D preferentially, an extra band may be secured in advance for such a traffic flow. For example, in a time interval in which traffic flows are transmitted at a bandwidth requested for Class C but no traffic flows belonging to Class D are transmitted, traffic flows belonging to Class C are transmitted in advance using the extra band. As a result, there will be no need to transmit those traffic flows belonging to Class C that have already been transmitted in advance. That is to say, this means reserving an extra band for the future. Specifically, in a time interval in which no traffic flows belonging to Class D are transmitted, traffic flows belonging to Class C are transmitted at a rate exceeding the requested bandwidth. As a result, the sum of the traffic flows belonging to Class C to be transmitted in the future can be reduced and the extra band can be used to transmit other traffic flows. Consequently, the interference with traffic flows belonging to Class C can be reduced and the time delay to be caused by traffic flows belonging to Class D can be shortened.

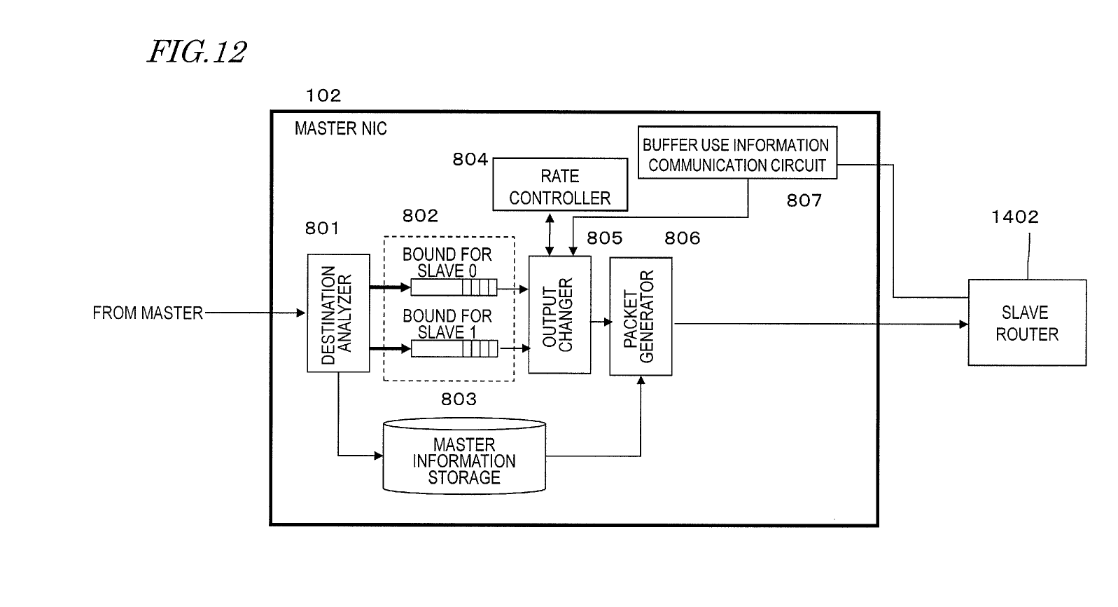

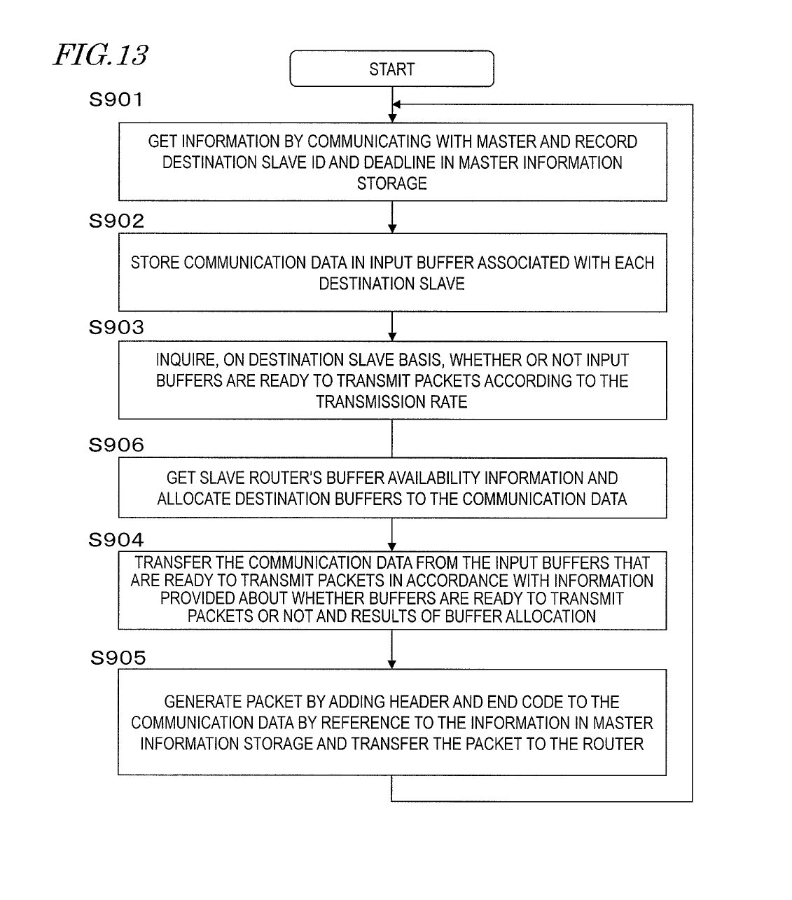

FIG. 12 illustrates a configuration for the master NIC 102, which is comprised mostly of hardware circuits. Each component of the master NIC 102 is implemented as a combination of multiple circuit elements. Alternatively, each component may also be implemented as either a single integrated circuit or multiple integrated circuits.

The master NIC 102 includes a destination analyzing section 801, an input buffer section 802, a master information storage 803, a rate controller 804, an output changer 805, a packet generator 806 and a buffer use information communication circuit 807.

The destination analyzing section 801 communicates with the bus master 101 to receive the communication data 201, a destination slave ID 705, a deadline time 707 and a source ID 704 and store the respective data.

The input buffer section 802 stores the communication data 201 on a destination basis.

The master information storage 803 stores what the destination analyzing section 801 has gotten by communicating with the bus master 101, i.e., the source ID 704 identifying that bus master 101, the class to which the bus master 101 belongs, the deadline time 707, or the destination slave ID 705.

The rate controller 804 determines the transmission rate based on the rate value that has been set in advance in the rate value storage 1003 and controls the transmission rate of packets. In this description, the rate controller will be sometimes referred to herein as a “transmission controller”.

A bus master which is going to transmit performance-ensuring data, on which a strict performance requirement is imposed, sets the transmission rate to be a transmission rate that needs to be guaranteed. On the other hand, a bus master which is going to transmit data at a rate exceeding the requested bandwidth either sets the traffic flow rate value (upper limit value) to be a transmission rate exceeding the requested bandwidth or does not set the traffic flow rate value (upper limit value) at all in order to use the extra band. With respect to a traffic flow in the non-performance-ensured class, the bus master does not set the traffic flow rate value (upper limit value). As a result, the traffic flow is always ready to be transmitted and can be transmitted using the extra band.

It should be noted that if the rate value (upper limit value) is set to be a transmission rate exceeding the requested bandwidth, then the rate value (upper limit value) could be determined based on the processing ability of a node or link that would cause a bottleneck for the entire bus system. For example, suppose a particular link would cause a bottleneck where the traffic flow becomes the heaviest in the entire bus system. In that case, the transmission performance of that link is determined based on the operating frequency and width of the bus so as to use the link with maximum efficiency, and the transmission rate (upper limit value) is determined based on the transmission performance. Alternatively, in such a situation, a certain use case may be supposed and the extra band, and eventually the rate value, may be determined by subtracting the requested bandwidth of the performance-ensuring data that has been transmitted from another bus master. Also, if the slave is a memory, a bottleneck could be produced depending on the ability of the memory to process the communication data. That is why the transmission rate (upper limit value) can be set to be high enough for the memory to transmit a size of data that can be processed continuously. As a result, the bottleneck of the bus system can be used most efficiently without transmitting a traffic flow at an excessively high rate.

The output changer 805 changes the buffers for transmission according to the communication data 201 stored in the input buffer section 802, information provided by the rate controller 804 about whether or not the packets are ready to be transmitted, and information provided by the buffer use information communication circuit 807 about buffers available from the slave router 1402, and outputs the data stored in the input buffer section 802 to the packet generator 806.

The packet generator 806 converts the communication data provided by the output changer 805 into packets, divides each of those packets into flits, and then transmits the flits. In converting the communication data into packets, the packet generator 806 adds a header and an end code to the data to be communicated, as will be described later.

FIG. 13 shows the flow of operation of the master NIC 102.

The destination analyzing section 801 gets information by communicating with the bus master 101 and records the destination slave ID and deadline of the traffic flow to be transmitted to the master information storage 803 (in Step S901). Information about the deadline is added to each packet by the master NIC 102. Also, in this embodiment, the permitted time delay may be represented by the maximum relative time (difference) between a point in time when a packet is transmitted from a source node and a point in time when the packet arrives at a destination node. Meanwhile, the deadline is represented by an absolute time by which the packet should arrive at the destination node. Both of the time delay and deadline may be represented as either absolute times or relative times as well.

The destination analyzing section 801 stores the communication data 201 received in an input buffer associated with each destination slave in the input buffer section 802 (in Step S902).

The output changer 805 inquires of the rate controller 804 whether or not input buffers are ready to transmit packets. In response to the inquiry, the rate controller 804 informs the output changer 805 about whether input buffers are ready to transmit packets or not so that the transmission rate that has been set is not exceeded (in Step S903).

The buffer use information communication circuit 807 gets information about available buffers from the slave router 1402. In accordance with the buffer availability information provided by the buffer use information communication circuit 807, the output changer 805 allocates available buffers at the destination to the communication data that is stored in the input buffer section 802.

In accordance with the information provided about whether buffers are ready to transmit packets or not and the results of the buffer allocation, the output changer 805 transfers the communication data 201 from the input buffers that are ready to transmit packets (in Step S904).

The packet generator 806 generates a header 701 for the communication data 201 received based on the information provided by the master information storage 803 (including the source ID 704, the destination slave ID 705, the deadline 707, and the class 706 that has been set in advance with respect to the master information storage 803) and the input buffer number 708 that is the buffer allocation result. Then, the packet generator 806 generates a packet 202 by adding the header 701 and the end code 702 to the communication data 201, divides the packet 202 into flits, and transfers those flits (in Step S905).

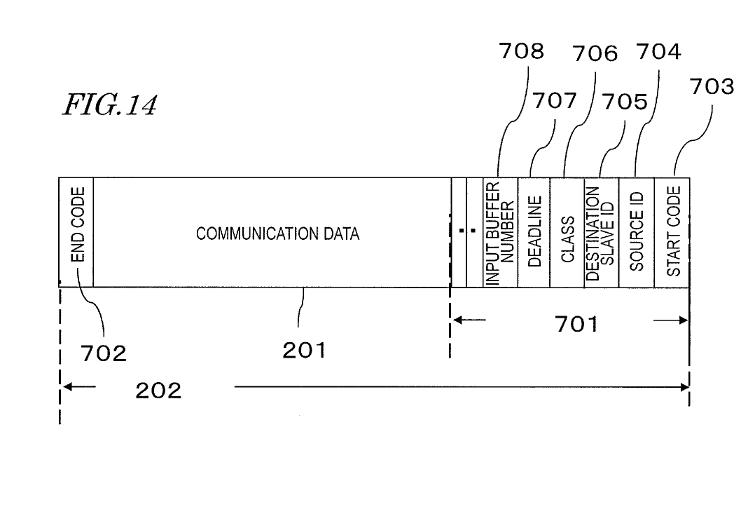

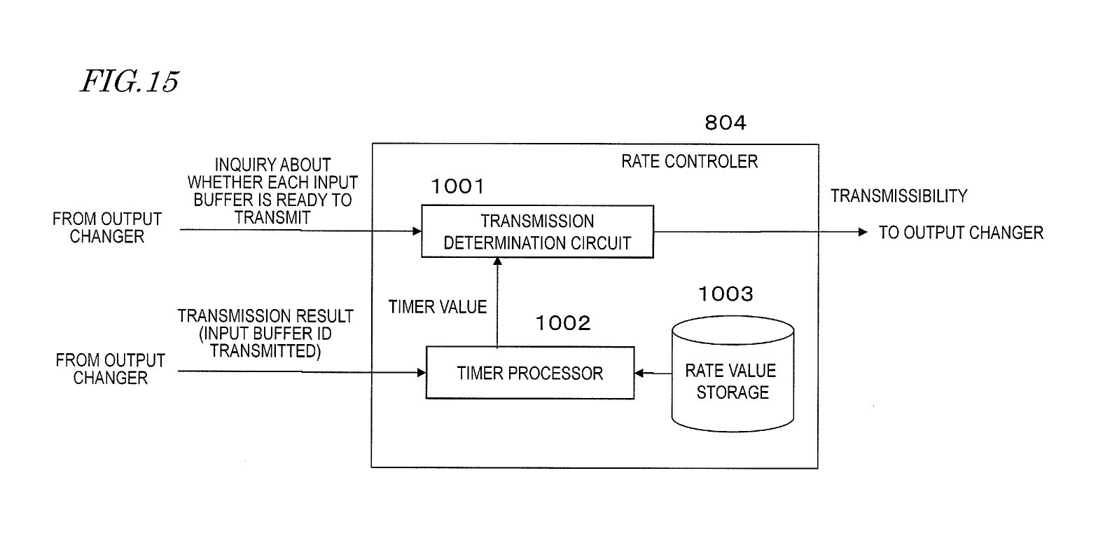

FIG. 14 illustrates a data structure for each packet 202.

The packet 202 includes communication data 201, header information 701 and an end code 702.

The communication data 201 is real data to be communicated between the bus master 101 and the slave 105 and may be moving picture or audio data, for example.

The header information 701 includes information about a start code 703 indicating the beginning of a packet, a source ID 704 to identify the master, a destination slave ID 705 to identify the slave that is the target, a class 706 to which a given traffic flow belongs, a deadline 707 by which the communication data should arrive at either the slave 105 or the bus master 101, and an input buffer number allocation result 708 which is stored in each router 103.

The end code 702 is a piece of information indicating the end of a packet.

According to this embodiment, by generating the header 701 including the class 706 in generating the packet 202, the router 103 can transmit data on a class-by-class basis. In this case, the class 706 just needs to be a piece of information that indicates the class of given data to be determined by its required performance (which will be referred to herein as “classification information”). Thus, the packet may be generated so as to include information about the order of priorities of transmission of respective data classes, for example, instead of the class 706. As another exemplary piece of information that indicates the class of given data, a packet may be generated so as to include a combination of the buffer numbers that can be stored in each router, and the order of priorities of transmission may be determined by the buffer numbers stored in the router.

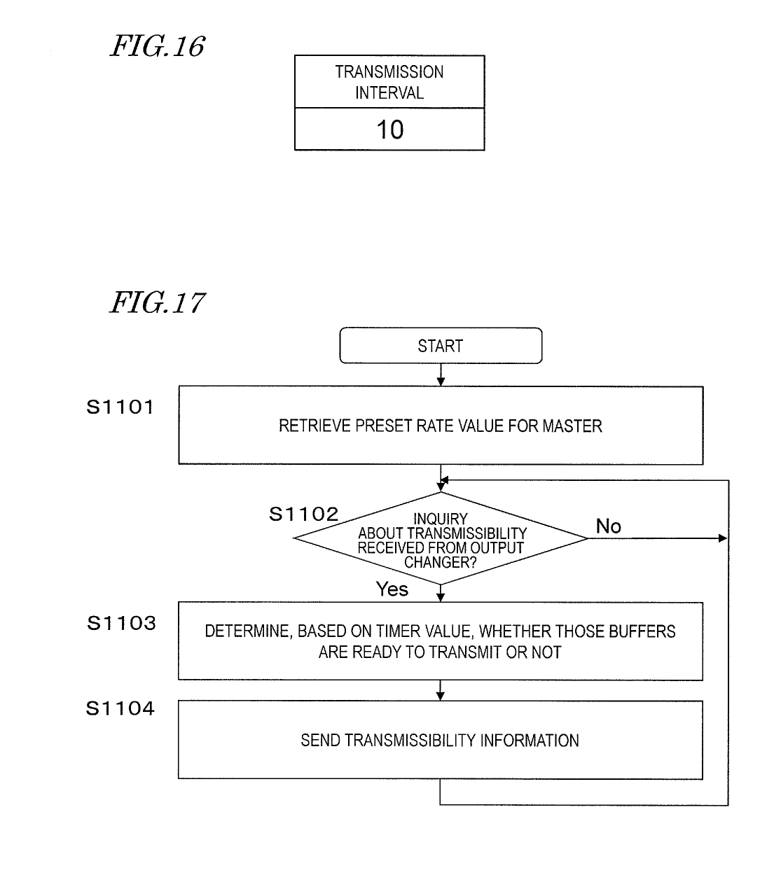

FIG. 15 illustrates a configuration for the rate controller 804 that is provided for the master NIC 102.

The rate controller 804 includes a transmission determination circuit 1001, a timer processor 1002 and a rate value storage 1003.

On receiving an inquiry about whether or not respective input buffers are ready to transmit packets from the output changer 805, the transmission determination circuit 1001 determines, based on the transmission rate, whether those buffers are ready to transmit packets or not, and notifies the output changer 805 of the result of the decision.

The timer processor 1002 includes a timer for measuring the transmission interval of packets 201 in order to control the transmission rate.

The rate value storage 1003 stores the values of preset transmission rates in order to control the transmission rate of packets to be transmitted from the master.

In the rate controller 804, respective components may be implemented as different pieces of hardware. For example, each of the transmission determination circuit 1001 and the timer processor 1002 may be implemented as either a combination of multiple circuit elements or a single integrated circuit. The rate value storage 1003 may be loaded with the transmission rate either by retrieving the transmission rate from a nonvolatile memory when the power is turned ON to start the bus system or by getting a preset transmission rate from another node through a signal line. Optionally, the rate controller 804 may be implemented as a combination of a computer program and a computer (integrated circuit) that executes that program.

FIG. 16 shows a rate value stored in the rate value storage 1003. If the transmission rate is controlled by the transmission interval of packets, a transmission interval value is set in advance. The transmission rate may be either set to be the same value for each class or set individually on a master-by-master basis. It should be noted that the term “transmission interval” is shown in FIG. 16 just for convenience sake and does not have to be stored actually. Instead, by clearly defining the storage area, either the transmission interval value itself or information corresponding to the transmission interval value (i.e., information indicating the value of the transmission rate) just needs to be held.

The same can be said about any of the drawings to be referred to in the following description. That is to say, even if the data structure is described in a similar format, the characters shown on the first row do not have to stored actually.

FIG. 17 shows the flow of operation of the rate controller 804.

The timer processor 1002 retrieves a preset rate value from the rate value storage 1003 (in Step S1101). Specifically, with respect to a class to be grouped as a time-delay-guaranteed class, a rate value that ensures the performance in terms of a time delay and a throughput may be set. On the other hand, with respect to a class to be grouped as a non-time-delay-guaranteed class, no upper limit is set with respect to the rate value in order to use the extra band with maximum efficiency.

On receiving an inquiry about whether the input buffers in the input buffer section 802 are ready to transmit packets or not from the output changer 805 (i.e., if the answer to the query of the processing step S1102 is YES), the transmission determination circuit 1001 determines, based on the timer value provided by the time processing section 1002, whether those buffers are ready to transmit packets or not (in Step S1103).

And the transmission determination circuit 1001 provides the transmissibility information thus obtained for the output changer 805.

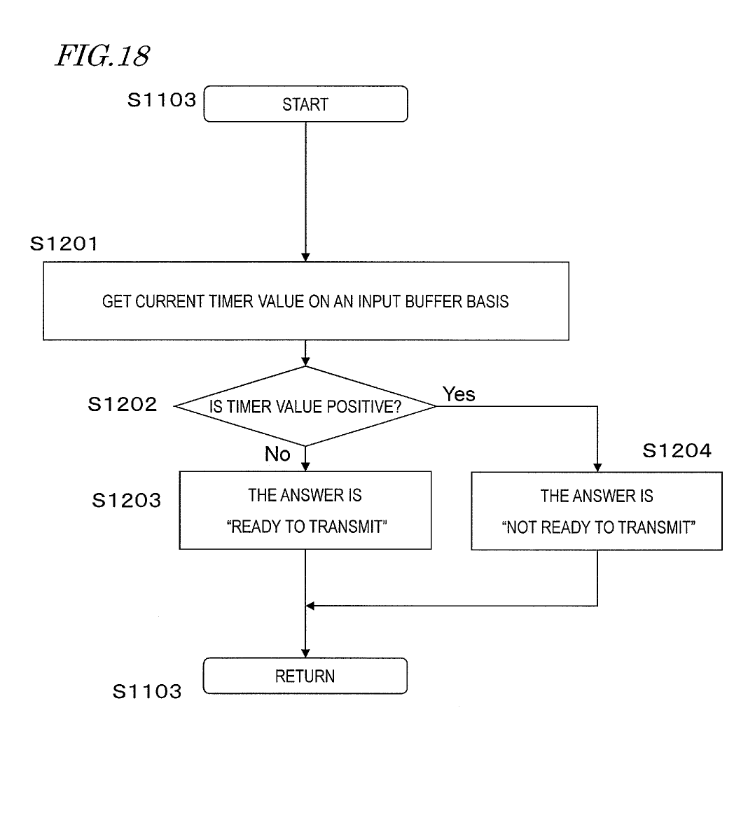

FIG. 18 shows how the transmission determination circuit 1001 performs the transmission determining processing step S1103.

The transmission determination circuit 1001 gets the current timer value from the timer processor 1002 on an input buffer basis (in Step S1201).

If the timer value is not positive (i.e., if the answer to the query of the processing step S1202 is NO), then the answer is “those buffers are ready to transmit”. On the other hand, if the timer value is positive (i.e., if the answer to the query of the processing step S1202 is YES), then the answer is “those buffers are not ready to transmit”.

FIG. 19 shows the flow of operation of the timer processor 1002.

The timer processor 1002 carries out a timer control in order to control the transmission rate. Before starting its processing, first of ail, the timer processor 1002 resets the value of its own timer into zero. Next, if the timer processor 1002 has received the result of transmission in transmitting the communication data from the input buffer (i.e., if the answer to the query of the processing step S1302 is YES), the timer processor 1002 sets the timer value to be the rate value that has been retrieved from the rate value storage 1003.

After that, the timer processor 1002 decrements the timer value every cycle of the bus' operating frequency until the timer value gets equal to zero (in Step S1304).

According to this processing, while the timer value is positive, the timer processor 1002 refrains from transmitting the communication data 201 that is stored in the associated buffer. In this manner, the transmission rate can be controlled so as not to exceed the preset rate value. However, the transmission rate may also be controlled by any method other than what has just been described, as mentioned above.

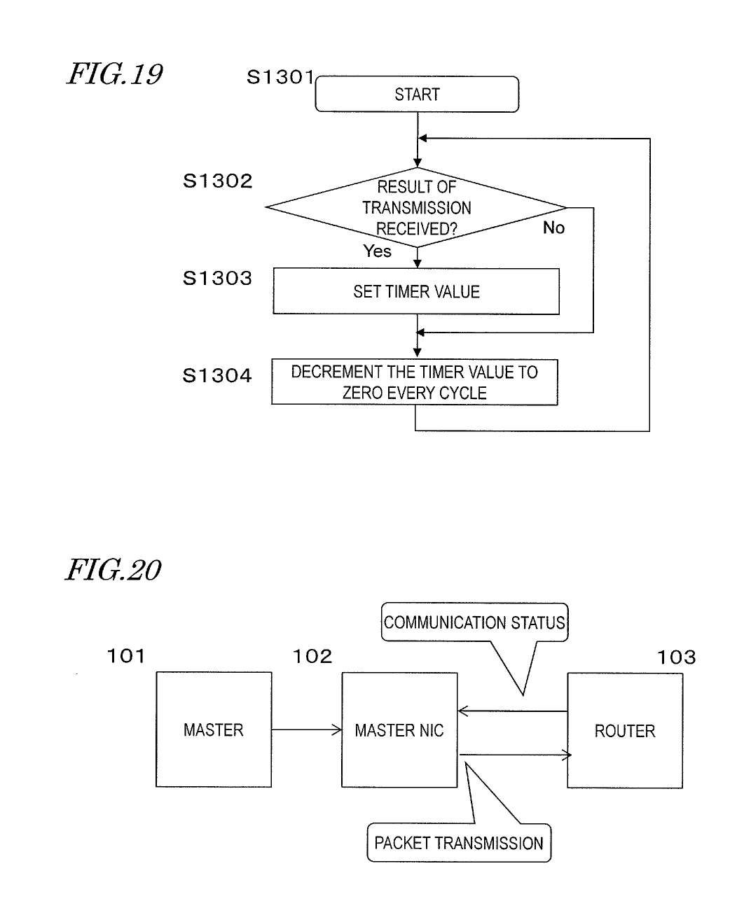

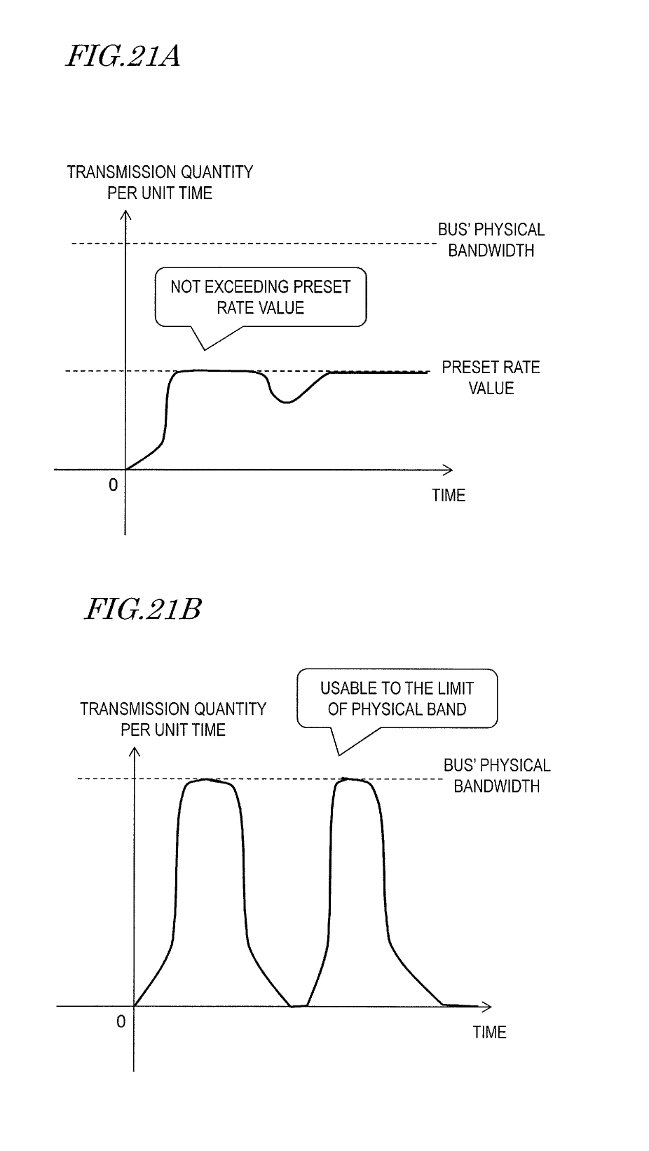

FIG. 20 illustrates how to carry out a general flow control between the master NIC 102 and the router 103. In this description, the “flow control” refers herein to receiving the communication status at the destination and controlling the transmission of packets according to the communication status. For example, the control to be performed by the master NIC 102 that gets buffer availability information from routers on the route leading from the source to the destination and from the slave NIC and that transmits the packets by reference to the buffer availability information is an exemplary flow control.

FIGS. 21A and 21B show how the flow control and rate control are different. FIG. 21A shows how the transmission quantity per unit time changes if the rate control is performed, while FIG. 21B shows how the transmission quantity per unit time changes if no rate control is performed. As shown in FIG. 21A, by performing the rate control, the transmission quantity per unit time of the packets being transmitted from either the master NIC or the router is controlled so as not to exceed the preset rate value (upper limit value). On the other hand, if the flow control is carried out without performing any rate control, the transmission control by the flow control within the physical band prevails as shown in FIG. 21B. For example, in that case, the packets can be transmitted using the entire physical band of the bus without being restricted by the transmission rate. Also, even when the rate value (upper limit value) is set so as to exceed the requested bandwidth, the transmission control by the flow control will also prevail if the rate value is set to be a sufficiently large value. Also, as for the flow control of this embodiment, the router 103 and the master NIC 102 perform a flow control by transmitting packets by reference to the buffer availability information in the input buffer section at the destination.

<Router>

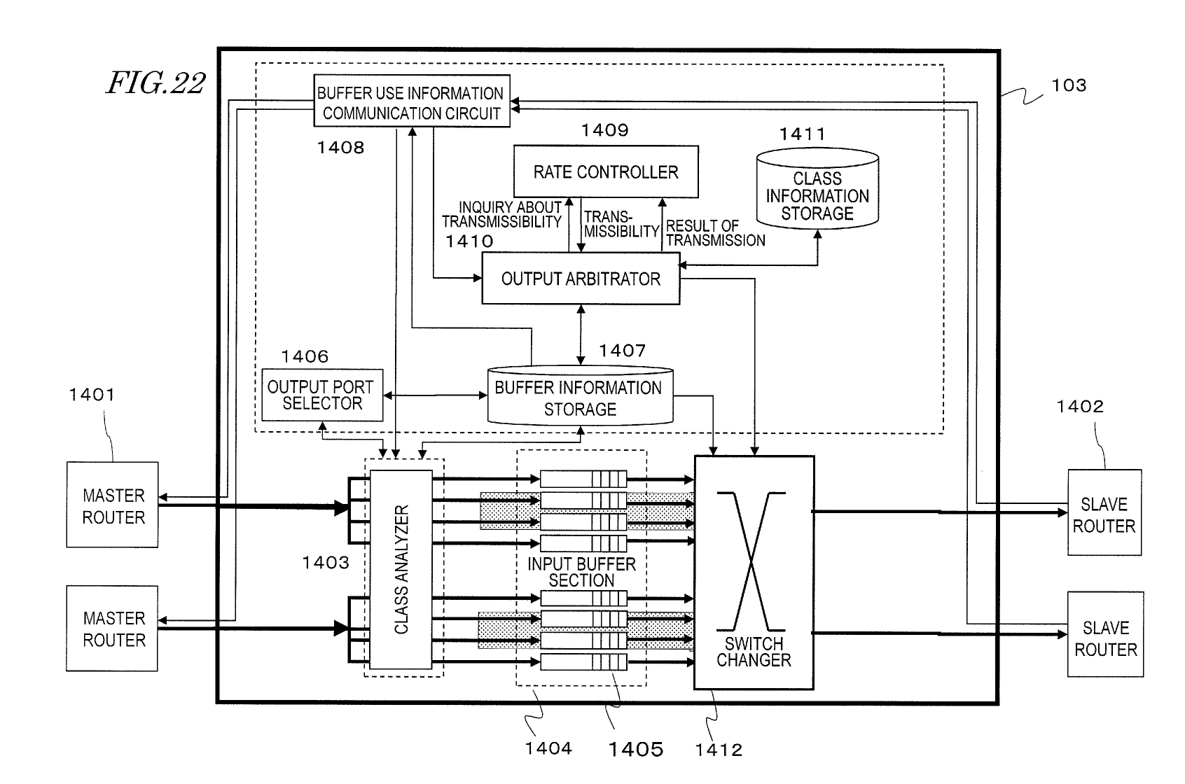

FIG. 22 illustrates a configuration for the router 103.

The router 103 receives a packet 202 from either a master router 1401 or a master NIC 102 and transmits the packet 202 to either a slave router 1402 or a slave NIC 104. The master and slave are connected together through bus lines.

The router 103 includes a class analyzer 1403, an input buffer section 1404, an output port selector 1406, a buffer information storage 1407, a buffer use information communication circuit 1408, a rate controller 1409, an output arbitrator 1410, a class information storage 1411 and a switch changer 1412.

The class analyzer 1403 receives the packet 202, and analyzes the header information 701 by reference to the packet's start code, thereby getting the class, destination slave ID and deadline. In addition, the class analyzer 1403 gets the buffer availability information in the slave router 1402 from the buffer use information communication circuit 1408 and allocates input buffers according to the class. The result of the allocation will be stored in the buffer information storage 1407.

The input buffer section 1404 stores the packets on a class-by-class basis.

The output port selector 1406 determines the output port number by the destination slave ID that has been gotten by the class analyzer 1403 and stores the output port number in the buffer information storage 1407.

The buffer information storage 1407 stores various kinds of information about the packet 202 that is stored in the input buffer section 1404 (including the class, destination slave ID, deadline, output port number, and result of allocation of the input buffers to the slave master).

The buffer use information communication circuit 1408 gets the buffer availability information from the slave router 1402, gets the available information in the input buffer section 1404 from the buffer information storage 1407, and provides the availability information for the buffer use information communication circuit 1408 in the master router 1401.

The rate controller 1409 gets the class of the packets 202 that are stored in the input buffer section 1404 from the buffer information storage 1407 and controls the transmission of the packets according to the packets' guaranteed transmission rate on a class-by-class basis. The transmission rate to be guaranteed on a class-by-class basis is determined based on the rate value that has been set in the rate value storage 2003 (not shown in FIG. 22 but to be described later).

The rate controller 1409 notifies the output arbitrator 1410 of the result of the rate control as a packet transmission permission signal. In response to the transmission permission signal received, the output arbitrator 1410 conducts arbitration so as to sequentially give high priorities to the packets, of which the transmission rates are equal to or lower than the guaranteed transmission rate, and give low priorities to the packets, of which the transmission rates exceed the guaranteed transmission rate.

The rate value to be set for the rate value storage 2003 (to be described later) is set to be equal to or greater than the guaranteed rate value that has been set by the master NIC 102 so that traffic flows belonging to the same class can be confluent to each other while maintaining their requested bandwidths. For example, if the rate control is carried out based on the transmission interval, the transmission interval of the router 103 is set using the value (P/N) which is obtained by dividing the transmission interval P that has been set by the master NIC 102 by the number of masters N belonging to the same class, thereby transmitting the traffic flows while maintaining their requested bandwidths. As for the non-time-delay-guaranteed class, on the other hand, no upper limit is imposed on the transmission rate so as to use the bus' extra band more efficiently.

To determine their order of transmission, the output arbitrator 1410 conducts arbitration between the packets to transmit according to the priority levels of classes that are stored in the class information storage 1411, the deadlines gotten from the buffer information storage 1407, and the transmission permission signal gotten from the rate controller 1409.

The class information storage 1411 stores in advance the priority levels of those classes.

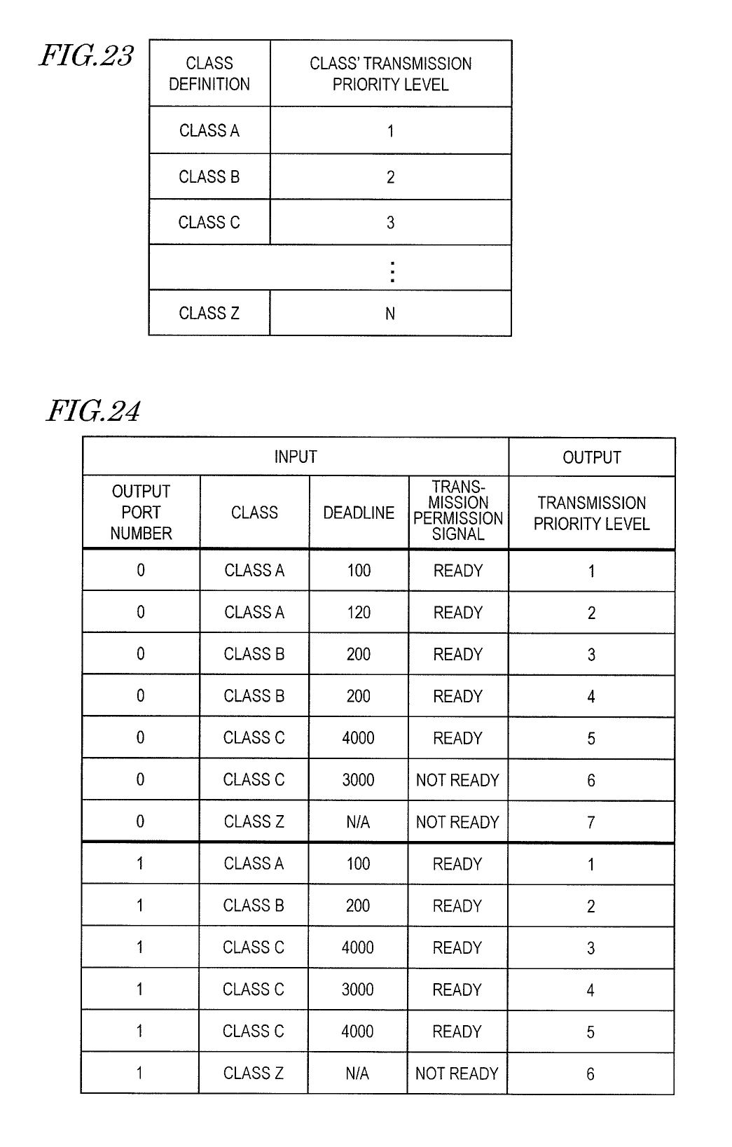

FIG. 23 shows the class priority level information to be stored in the class information storage 1411.

In this example, the lower the priority level of a given class is, the higher the priority given to its transmission processing is. For example, the priority level of Class A is “1”, and Class A is processed most preferentially. Meanwhile, since the priority levels of Classes B and C are “2” and “3”, respectively, Class B is processed second most preferentially, next to Class A. And Class C is processed after Class B. Naturally, any other arbitrary set of priority levels may be allocated according to the number of the classes designed.

Based on the priority levels and deadlines thus defined, the output arbitrator 1410 of the router 103 conducts arbitration and performs transmission processing between the input buffers in the descending order of their priority levels and in the ascending order of their deadlines (i.e., an input buffer with a higher priority level or a closer deadline than any other input buffer is processed most preferentially).

FIG. 24 shows a specific example of the results of the arbitration conducted by the output arbitrator 1410 of the router 103 between respective buffers to transmit packets from in order to determine their order of priorities. Suppose there are packets at two output ports with two different numbers in input buffers that have been grouped into Classes A, B, C and Z. More specifically, suppose there are packets at Output Ports #0 and #1 in input buffers that have been grouped into Classes A, B, C and Z, for example. First of all, with respect to Output Port #0, the output arbitrator 1410 extracts input buffers belonging to a class with the highest priority level (e.g., input buffers in Class A) from input buffers in which packets that are ready to transmit are stored. Next, the output arbitrator 1410 further extracts an input buffer with the closest deadline from those input buffers extracted. On the other hand, if no input buffers have been extracted at all, then the output arbitrator 1410 extracts a single input buffer belonging to a class with the highest priority level or with the closest deadline from input buffers in which packets that are not ready to transmit are stored. In any case, the output arbitrator 1410 regards the input buffer that has been extracted as an input buffer to transmit packets from with respect to Output Port #0. Subsequently, the output arbitrator 1410 selects an input buffer to transmit packets from with respect to Output Port #1 through the same arbitration procedure.

Based on the result of the arbitration that has been conducted by the output arbitrator 1410 and the output port number that is stored in the buffer information storage 1407, the switch changer 1412 turns the switch and transmits the packets.

According to the method of this embodiment, the order of transmission of packets is supposed to be determined within the same class by comparing their deadlines to each other. The deadline may be any piece of information as long as the information indicates the degree of temporal urgency with which a given packet needs to be transmitted within the same class. For example, the deadline may be a time by which communication data should arrive at the destination slave or a time by which a response from the slave should arrive at the source master. Likewise, the permitted time delay may be either the amount of time it takes for a packet transmitted from a master to reach a slave through a forward route or the amount of time it takes for a packet transmitted from the source master to reach the slave and go back to the master through the forward and backward routes. The degree of temporal urgency with respect to transmission does not have to be represented by the deadline but may also be represented by the time when the packet was transmitted, the amount of time that has passed since the transmission time (i.e., information about the accumulated processing time at the master NIC 102 and the router 103) or the number of packets that have been transmitted so far up to the transmission time (i.e., the count of the transmission counter indicating the order of transmission of packets at the master NIC 102). In this description, these pieces of information will be sometimes referred to herein as “time information concerning the deadline” collectively.

When this semiconductor system is implemented, the time may be indicated by the count of a counter to be driven by a bus clock signal supplied to the semiconductor bus system, for example. If the amount of time that has passed since the transmission time is used instead of the deadline, the header needs to have a space to store the count of counter that measures the time passed instead of the deadline, and the count of the counter may be incremented by one at the master NIC 102 or the router 103 every operating clock pulse. Alternatively, if a transmission counter that indicates the order of transmission of packets instead of the deadline is used, the transmission counter may be provided for the packet generator 806, which may increment the count of its transmission counter every time a packet is transmitted, and the count of the transmission counter at the time of transmission may be added to the header. Although an up-counter is supposed to be used in this example, the up-counter may be naturally replaced with a down-counter.

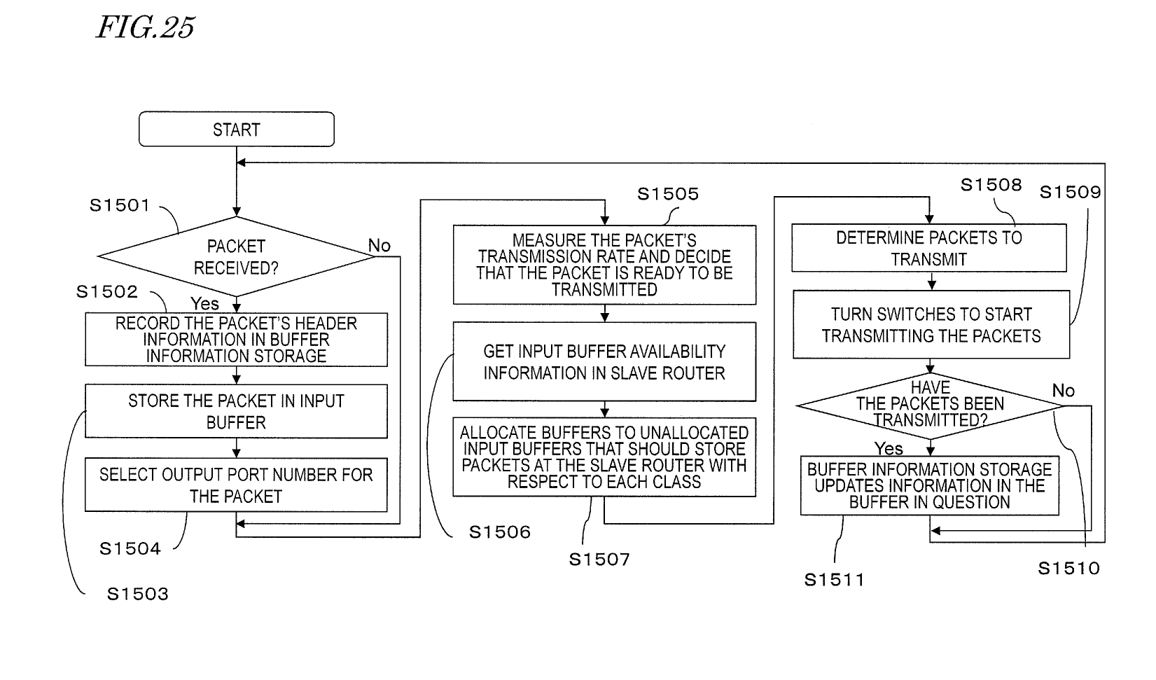

FIG. 25 shows the flow of operation of the router 103.

The class analyzer 1403 receives a packet 202 from the master router 1401 (in Step S1501).

Next, the class analyzer 1403 analyzes the header information 701 (including the destination slave ID, class and deadline) of the packet 202 and records the information in the buffer information storage 1407 (in Step S1502).

Then, the class analyzer 1403 extracts an input buffer number from the packet 202 and stores the packet in an associated input buffer 1405 in the input buffer section 1404 (in Step S1503).

Next, the output port selector 1406 selects an output port number for the packet 202 based on the destination slave ID (in Step S1504). The output port number may generally be selected either by using a routing table to be determined statically by how the router is connected or by making calculations using the destination slave ID following a certain rule, for example.

The rate controller 1409 measures the transmission rates of packets in respective classes with respect to each output port number, and decides that the packets stored in the input buffer section 1404 are ready to be transmitted so as to allow the output arbitrator 1410 to see if the actual transmission rate is greater than the preset rate value (in Step S1505). It should be noted that with respect to a traffic flow, for which the rate value (upper limit value) has been set by the rate controller 1409 to be the guaranteed rate value, that traffic flow rate can be guaranteed. In this description, such a traffic flow will be referred to herein as a “traffic flow to be transmitted using a first band (i.e., the band to be secured for that traffic flow)”. On the other hand, with respect to a traffic flow of which the rate value has been set to be greater than the guaranteed rate value, an extra band can be used with that transmission rate guaranteed. In this description, such a traffic flow will be referred to herein as a “traffic flow to be transmitted using the first band and a second band (i.e., the extra band)”. Furthermore, if no rate value (upper limit value) has been set with respect to the rate control, then the transmission interval may be set to be zero, for example. In that case, the traffic flow can be transmitted continuously and the extra band can be used to the upper limit of the bus' physical bandwidth at maximum.

The buffer use information communication circuit 1408 gets buffer availability information to be used when buffers are allocated in the slave router 1402 (in Step S1506). In this description, the buffer availability information indicates whether there are any packets stored in, and how many flits are available from, each of the input buffers 1405 that are allocated to the destination slaves in respective classes in the slave router 1402. It should be noted that if the input buffer section 1404 is comprised of a single randomly accessible memory and an address table which manages the addresses on a destination slave basis with respect to each class, then a plurality of packets can be stored in a single input buffer. That is why in that case, the number of packets available and the number of flits available are obtained on a destination basis with respect to each class, and used as pieces of the buffer availability information.

The class analyzer 1403 allocates buffers available from the slave router 1402 to unallocated input buffers that should store packets at the slave router on a destination slave ID basis with respect to each class (in Step S1507).

The output arbitrator 1410 conducts arbitration between the packets that are stored in the input buffer section 1405 and that are going to be transmitted in the descending order of priorities. And if there is any extra band available, the output arbitrator 1410 also conducts arbitration between even packets that the rate controller 1409 have found not ready to be transmitted to give them low priorities (in Step S1508). The rate controller 1409 in the router controls the transmission at a rate value (upper limit value) based on the requested bandwidth, thereby transmitting, if the bus has any extra band, either a traffic flow exceeding the requested bandwidth or a non-performance-ensured traffic flow while ensuring the required performance. In this manner, the extra band can be used more efficiently.

Based on the result of the decision that has been made by the output arbitrator 1410, the switch changer 1412 turns the switches in order to transmit the packet 202 and then does transmit the packet 202 (in Step S1509).

If the packet 202 has already been transmitted (i.e., if the answer to the query of the processing step S1510 is YES), the buffer information storage 1407 initializes the information stored in the input buffer in question (in Step S1511). Otherwise (i.e., if the answer to the query of the processing step S1510 is NO), the packet continues to be transmitted.

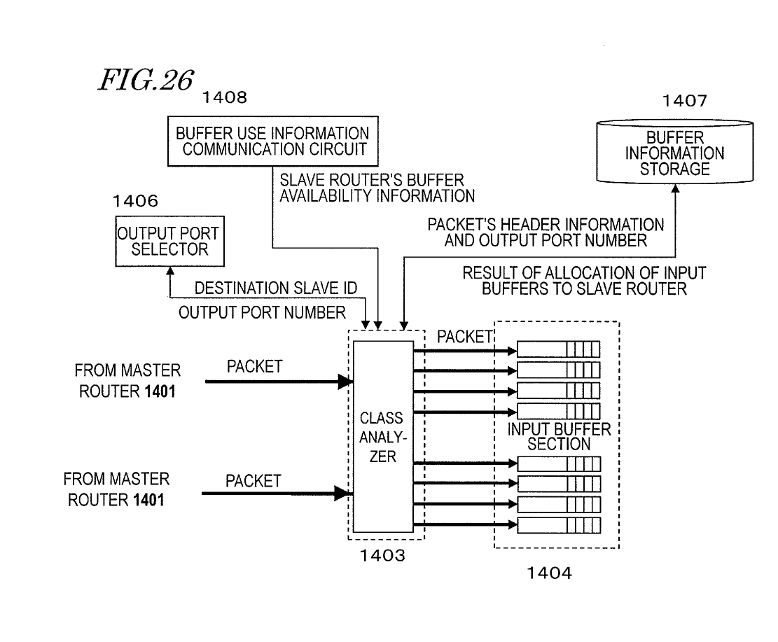

FIG. 26 shows what is input to, and output from, the class analyzer 1403 of the router 103.

The class analyzer 1403 receives a packet 202 from the master router 1401 and notifies the output port selector 1406 of the destination slave ID to determine where the packet 202 should be transferred. Then, the class analyzer 1403 gets an output port number and records the output port number in the buffer information storage 1407. Also, the class analyzer 1403 retrieves the buffer availability information of the slave router 1402 from the buffer use information communication circuit 1408 on a destination slave ID basis with respect to each class in order to allocate an input buffer in the slave router 1402. Then, the class analyzer 1403 makes the buffer information storage 1407 record the header 701 and output port number of the packet 202. And the class analyzer 1403 makes the input buffer section 1404 store the packet 202.

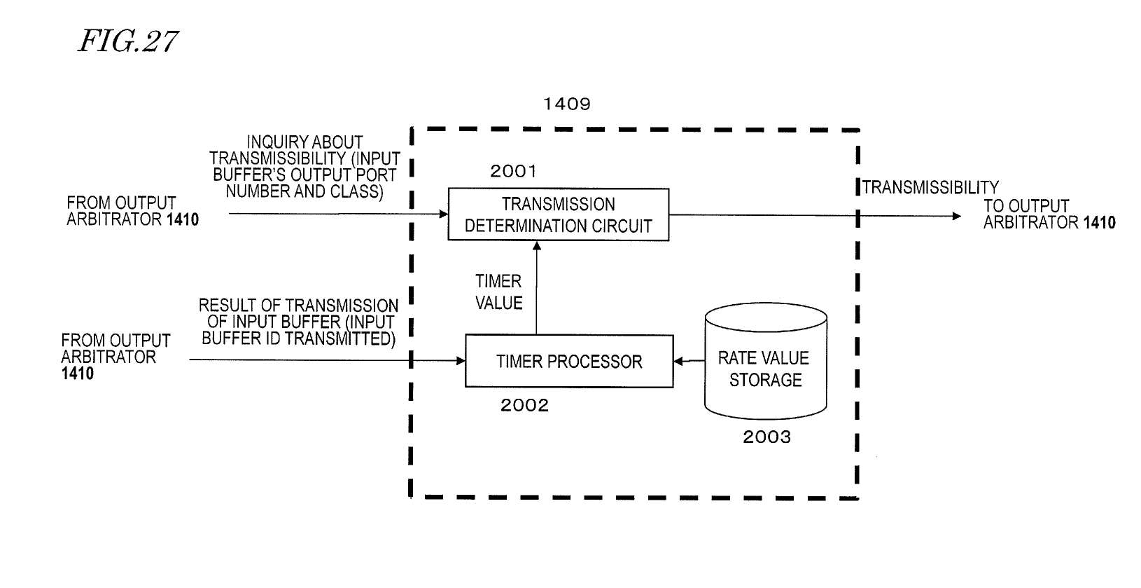

FIG. 27 illustrates a configuration for the rate controller 1409 of the router 103. Just like the rate controller 804 of the master NIC 102, this rate controller 1409 also controls the rate by adjusting the transmission interval of packets using a timer. The timer processor 2002 manages its timer independently on an output port number basis with respect to each class. And the transmission determination circuit 2001 gets a timer value on an output port number basis with respect to each class and determines whether or not the buffers are ready to transmit packets. A rate value that has been set on a class-by-class basis is stored in the rate value storage 2003. And by seeing if the transmission rate exceeds that rate value, the decision is made, on an output port basis with respect to each class, whether the input buffers are ready to transmit packets or not. Optionally, in order to use the extra band, the output arbitrator 1410 sometimes gets packets transmitted from input buffers that are not ready to transmit packets. Also, the rate value of each class may be set in advance by the designer according to the performance required. For example, with respect to a performance-ensured traffic flow, the rate value is set to be the guaranteed transmission rate. With respect to a non-performance-ensured traffic flow, on the other hand, no rate value (upper limit value) is set. Furthermore, if no upper limit rate value is set, the transmission interval may be set to be zero, for example.

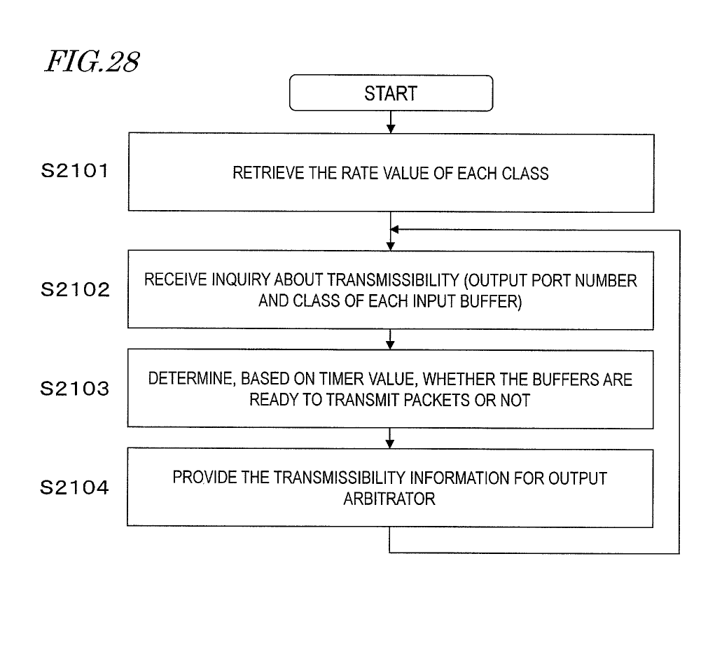

FIG. 28 shows the flow of operation of the rate controller 1409.

First of all, the timer processor 2002 of the rate controller 1409 retrieves the rate value of each class from the rate value storage 2003 (in Step S2101).

Next, the transmission determination circuit 2001 gets the output port number and class of each input buffer from the output arbitrator 1410 (in Step S2102).

Subsequently, the transmission determination circuit 2001 determines, based on the timer value provided by the timer processor 2002, whether the buffers are ready to transmit packets or not, with respect to the output port number and class gotten (in Step S2103).

And the transmission determination circuit 2001 provides the transmissibility information for the output arbitrator 1410 (in Step S2104).

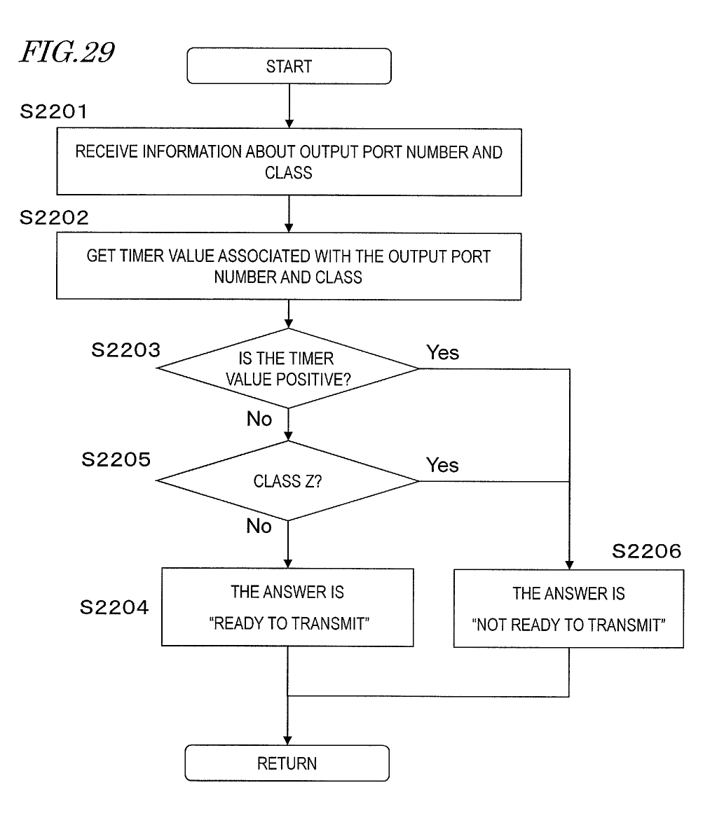

FIG. 29 shows the procedure in which the rate controller 1409 performs the transmission determining processing step.

First of all, the transmission determination circuit 2001 of the rate controller 1409 receives information about the output port number and class from the output arbitrator 1410 (in Step S2201).

Next, the transmission determination circuit 2001 gets a timer value associated with the output port number and class from the timer processor 2002 (in Step S2202).

If the timer value gotten is positive (i.e., if the answer to the query of the processing step S2203 is YES), the transmission determination circuit 2001 decides that the buffers are not ready to transmit packets. On the other hand, unless the timer value gotten is positive (i.e., if the answer to the query of the processing step S2203 is NO), the transmission determination circuit 2001 decides that, if the answer to the query of the processing step S2205 is NO, the buffers are ready to transmit packets with respect to a performance-ensured class (i.e., unless the buffer belongs to Class Z) (in Step S2204) but decides that, if the answer to the query of the processing step S2205 is YES, the buffers are not ready to transmit packets with respect to a non-performance-ensured class (i.e., when the buffer belongs to Class Z) (in Step S2206).

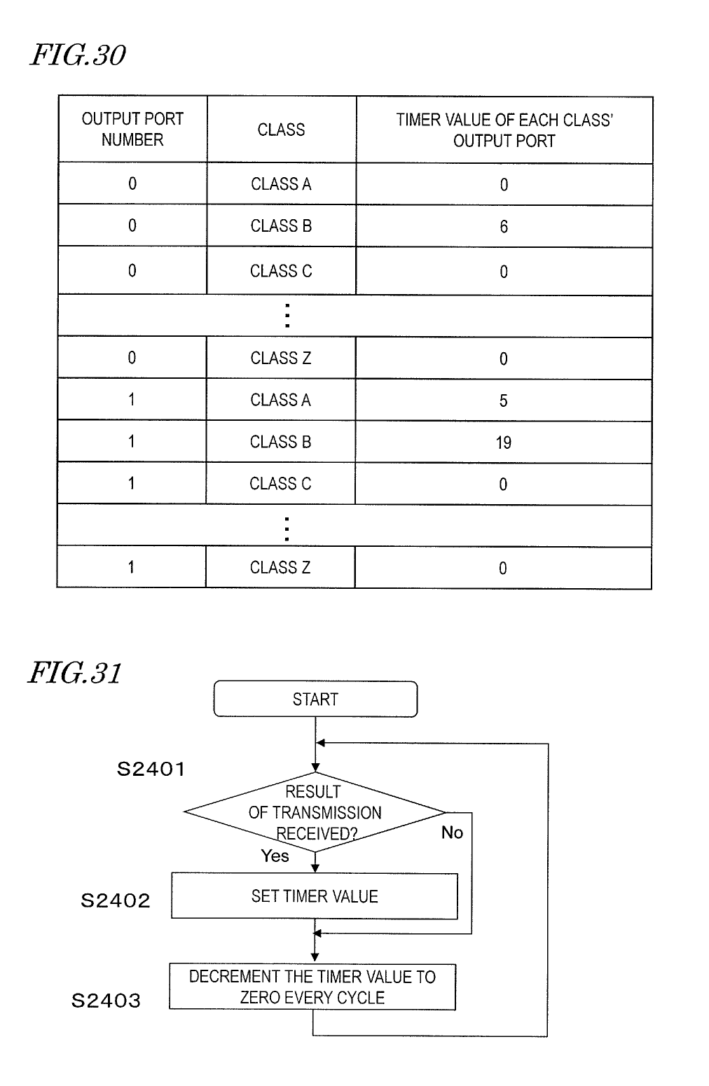

FIG. 30 shows a specific example of the management information for the timer processor. For example, the second row of the table shown in FIG. 30 says that the timer value associated with Class A at Output Port #0 is zero. If the timer value is zero, then it means that no packets have been transmitted for at least as long a period of time as the preset transmission interval since the packets were transmitted last time, and therefore, this is a “transmissible” state. Meanwhile, the third row of this table says that the timer value associated with Class B at Output Port #0 is six. This means that this is a “non-transmissible” state in which transmission is prohibited in order to set the packet transmission rate to be equal to or smaller than the transmission rate that has been set in the rate value storage 2003. However, this also means that the time value will be zero, and the “transmissible” state will be recovered again, in six cycles. Also, if no rate value is set with respect to a non-performance-ensured class, the timer value can always be kept zero through the operation to be described later by setting the transmission interval to be zero. As for the non-performance-ensured class (such as Class Z), processing is always carried out with low priorities, and therefore, transmission is always prohibited irrespective of the timer value. Furthermore, in the case of a class in which packets are transmitted at a rate exceeding the requested bandwidth (e.g., in Class C) or the non-performance-ensured class, if there are no transmissible packets in the input buffer, some packets may be transmitted even in the non-transmissible state. As a result, the bus' extra band can be used.

FIG. 31 shows the flow of operation of the timer processor 2002 of the rate controller 1409.

The timer processor 2002 resets each timer value into zero when starting to operate. And if the timer processor 2002 receives the result of transmission (i.e., the class and output port number of the input buffer that have been transmitted) from the output arbitrator 1410 when transmitting the packets (i.e., if the answer to the query of the processing step S2401 is YES), the timer processor 2002 sets the associated timer value to be the rate value that has been set in the rate value storage 2003 (i.e., the transmission interval in this case). No matter whether the result of transmission has been received (i.e., if the answer to the query of the processing step S2401 is YES) or not (i.e., if the answer to the query of the processing step S2401 is NO), the timer value is decremented by one every cycle of the bus' operating frequency and will eventually be decreased to zero (in Step S2403). Although the timer processor 2002 of this embodiment controls the transmission rate for the router 103, the transmission rate may also be controlled by any other method. Specifically, the transmission rate may also be controlled by the bit rate. Alternatively, the number of cycles in which packets are transmitted for a certain period of time may be specified. Still alternatively, the transmission interval may also be specified on a time basis, not on a cycle basis. Depending on what embodiment is adopted, as long as the transmission rate is satisfied in the long term, the transmission rate may exceed a sufficiently low rate for just a short period of time.

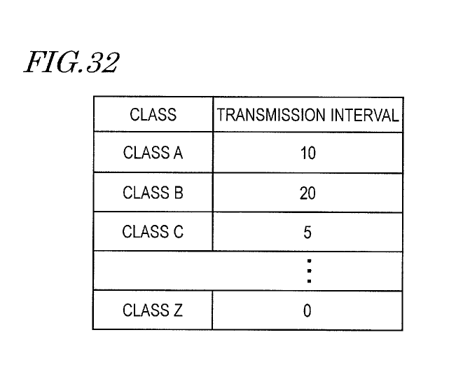

FIG. 32 shows exemplary transmission rate values that are managed by the rate value storage 2003 on a class-by-class basis. For example, if the rate is controlled by the transmission interval, the value that has been set represents the transmission interval. Specifically, in FIG. 32, the value of Class A is set to be “10”, which means that packets can be transmitted every ten cycles at maximum from each output port of the router 103. As for Class Z, on the other hand, the value is set to be “0”, which means that packets in a traffic flow belonging to Class Z can be transmitted continuously at no transmission intervals from the router 103. It should be noted that the shorter the transmission interval that has been set, the higher the transmission rate (i.e., the longer the transmission interval, the lower the transmission rate). The rate value storage 2003 may set the transmission rate either by retrieving the transmission rate from a nonvolatile memory when the power is turned ON to start the bus system or by getting a preset transmission rate from another node through a signal line.

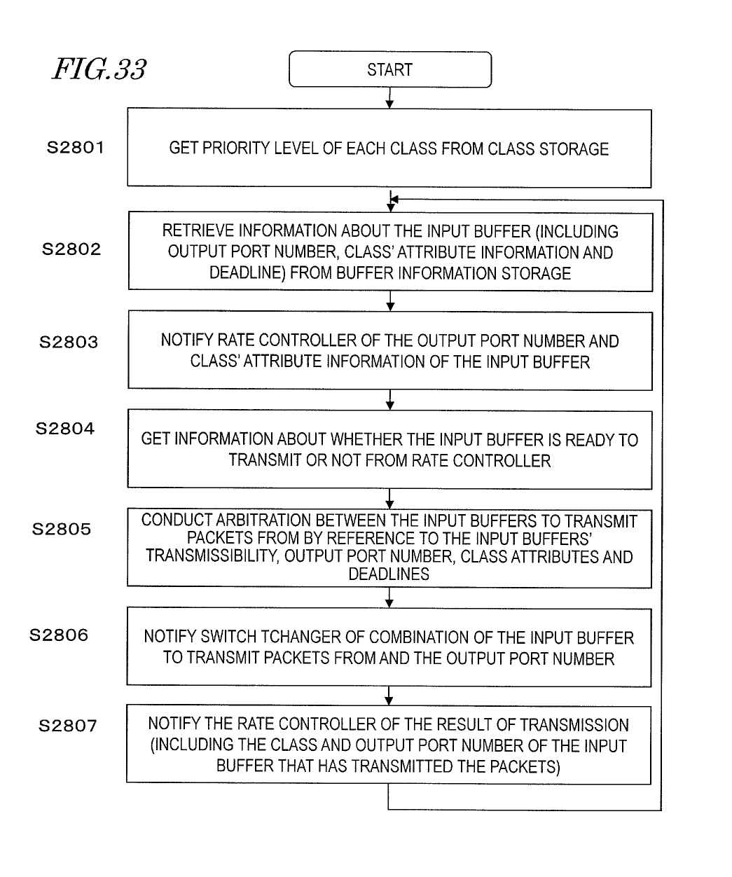

FIG. 33 shows the flow of operation of the output arbitrator 1410.

First of all, the output arbitrator 1410 gets the priority level of each class from the class information storage 1411 (in Step S2801).

Next, in order to select an input buffer 1415 to transmit packets from, the output arbitrator 1410 retrieves information about the input buffer 1415 (including the output port number, class' attribute information and deadline) from the buffer information storage 1407 (in Step S2802).

Subsequently, in order to inquire of the rate controller 1409 whether or not buffer is ready to transmit packets, the output arbitrator 1410 notifies the rate controller 1409 of the output port number and class' attribute information of the input buffer (in Step S2803) and gets information about whether the buffer is ready to transmit or not from the rate controller 1409 (in Step S2804).

Then, based on the transmissibility/non-transmissibility information, output port number, class' attribute information, and deadline thus gotten, the output arbitrator 1410 chooses a buffer with the highest class priority level from those input buffers that are ready to transmit packets from with respect to each output port number. If two or more buffers have the same priority level, then the output arbitrator 1410 chooses a buffer with the closest deadline from them. In this manner, the output arbitrator 1410 conducts arbitration between the input buffers to transmit packets from (in Step S2805).

Thereafter, the output arbitrator 1410 notifies the switch changer 1412 of the combination of the input buffer to transmit packets from and the output port number (in Step S2806) and then notifies the rate controller 1409 of the information about the input buffer 1415 to transmit the packets from (i.e., the class and output port number of that input buffer) (in Step S2807).

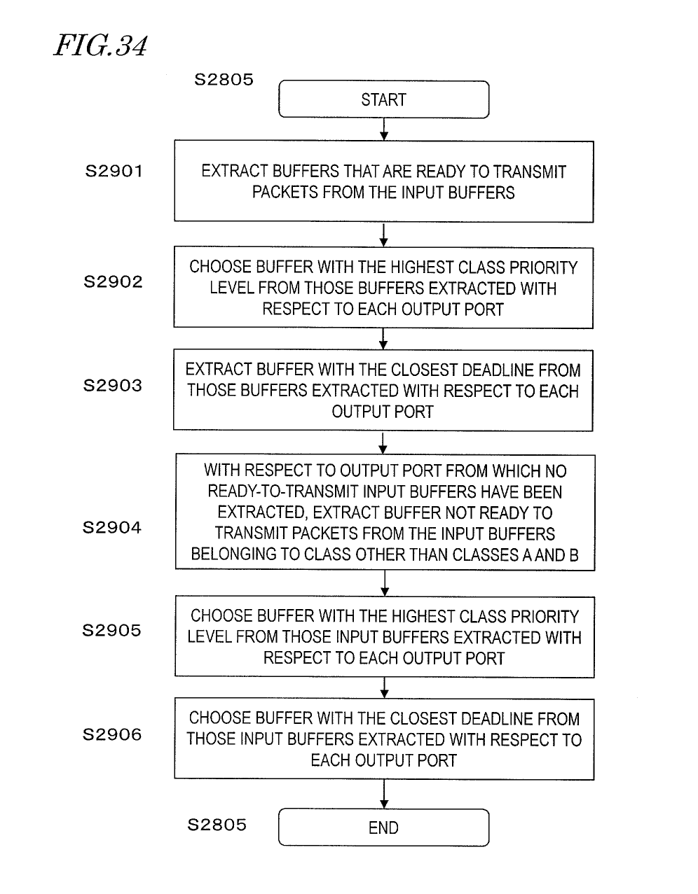

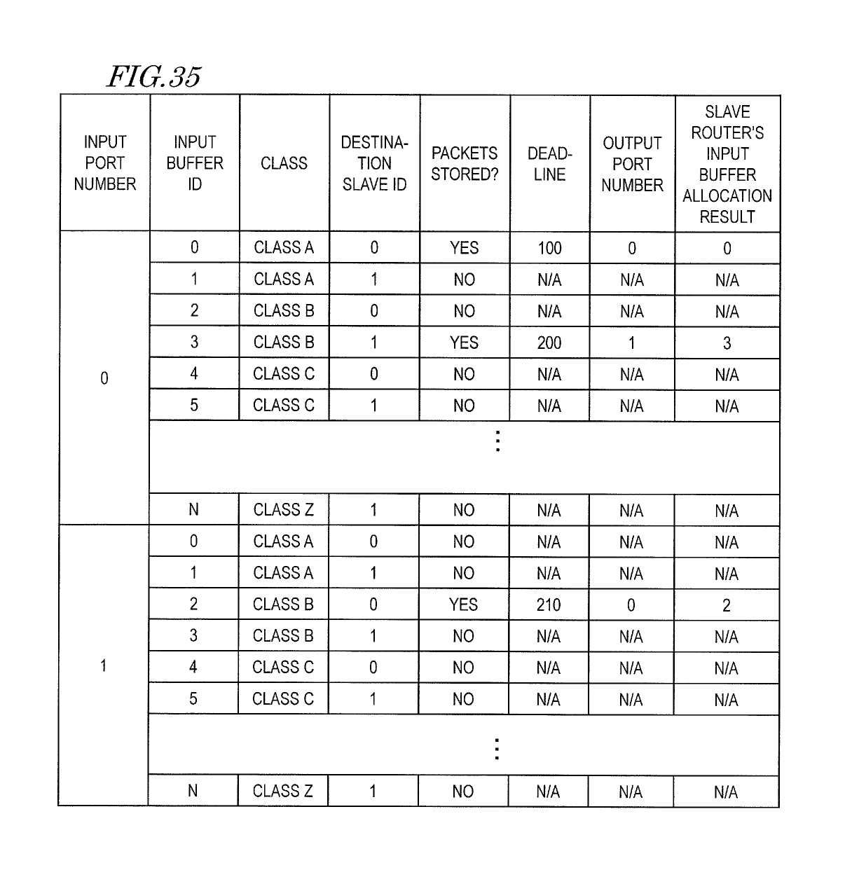

FIG. 34 is a flowchart showing how the output arbitrator 1410 carries out the processing step S2805 of conducting arbitration between the input buffers 1415 to transmit packets from.

The output arbitrator 1410 carries out a control operation so that input buffers that are ready to transmit packets are given high priorities and that input buffers that are not ready to transmit packets are given lower priorities than the former input buffers.

First of all, the output arbitrator 1410 extracts input buffers that are ready to transmit packets from the input buffers 1415 (in Step S2901) and then chooses an input buffer with the highest class priority level from those input buffers extracted with respect to each output port number (in Step S2902).

Next, the output arbitrator 1410 extracts an input buffer with the closest deadline with respect to each output port number and regards the input buffer as an input buffer to transmit packets from (in Step S2903).

Subsequently, with respect to an output port number from which no input buffers that are ready to transmit packets from have been extracted, the output arbitrator 1410 extracts an input buffer that is not ready to transmit packets from the input buffers 1415 belonging to a class other than Classes A and B with respect to each output port number (in Step S2904). Then, the output arbitrator 1410 chooses an input buffer with the highest class priority level from those input buffers extracted with respect to each output port number (in Step S2905). Finally, the output arbitrator 1410 chooses an input buffer with the closest deadline from those input buffers extracted with respect to each output port number (in Step S2906).

FIG. 35 shows a specific exemplary format for the management information to be stored in the buffer information storage 1407 of the router 103.

The buffer information storage 1407 stores the class and destination slave ID associated with each input buffer 1405. In addition, the buffer information storage 1407 also stores information about whether or not any packets are stored in each input buffer 1405, the deadlines, the output port numbers that have been selected based on the destination slave IDs, and the results of allocation of the input buffers (i.e., the input buffer IDs) at the slave router 1402.

For example, look at the item on the second row of the table shown in FIG. 35. This item represents pieces of information about the input buffer ID0 at Input Port #0 of the router 103. As indicated by this item, a packet belonging to Class A and having a destination slave ID of zero is stored in the input buffer 1405. The deadline of the packet is 100, and the output port number allocated to the packet by the output port selector 1406 is zero. And the input buffer ID allocated by the class analyzer 1403 to the slave router 1402 is zero.

The item on the third row of this table represents pieces of information about the input buffer ID1 at Input Port #0. As indicated by this item, a packet belonging to Class A and having a destination slave ID of one is stored in the input buffer 1405. As this item says it has no data, it can be seen that no packets are stored there.

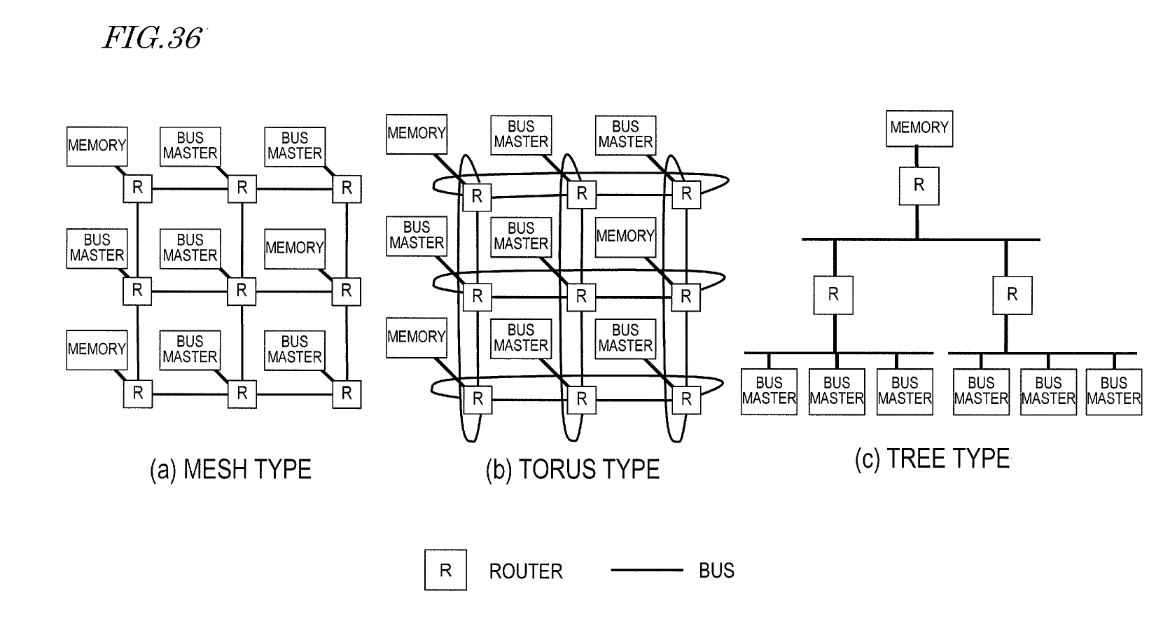

FIG. 36 illustrates exemplary NoCs which can be used as other embodiments of the present invention.

It should be noted that a router according to an embodiment of the present invention lowers the bus' operating frequency to ensure the required performance and uses the extra band more efficiently by dividing the buffers and controlling the transmission according to the required performance. That is why no matter how the routers are connected there, any of various types of NoCs such as the mesh, torus and tree types shown in portions (a), (b), and (c) of FIG. 36 can be used.

According to the embodiment described above, by grouping the buffers into respective classes as described above, the router can narrow the required bus bandwidth while minimizing the interference by low-priority classes. However, the buffers may also be grouped according to the types of packets.

There are two types of packets, namely, command-sending packets and data-sending packets.

And there are two types of commands. One type is a command including request information which needs to be used to read data when having a Read access to a slave. The other type is a command including data write response information when having a Write access to a slave. A Read request command is transmitted from a master and received at a slave. A Write response command is transmitted from a slave and received at a master.

Likewise, there are two types of data, too. One type is data including content to be written on a slave when having a Write access. The other type is data including content that has been read out from a slave when having a Read access. A packet including Write data is transmitted from a master and received at a slave. A packet including Read data is transmitted from a slave and received at a master.

For example, to decrease the delay involved with a Read access, the router may perform no rate control on a packet including a Read access command and may perform a rate control only on a packet including Write access data. In that case, by providing buffers separately for the command and the data, interference that would be caused due to a difference in controlling method between the command and the data can be reduced. As a result, the maximum time delay of the command can be estimated to be an even smaller value and the bus bandwidth to ensure the required performance can be reduced.

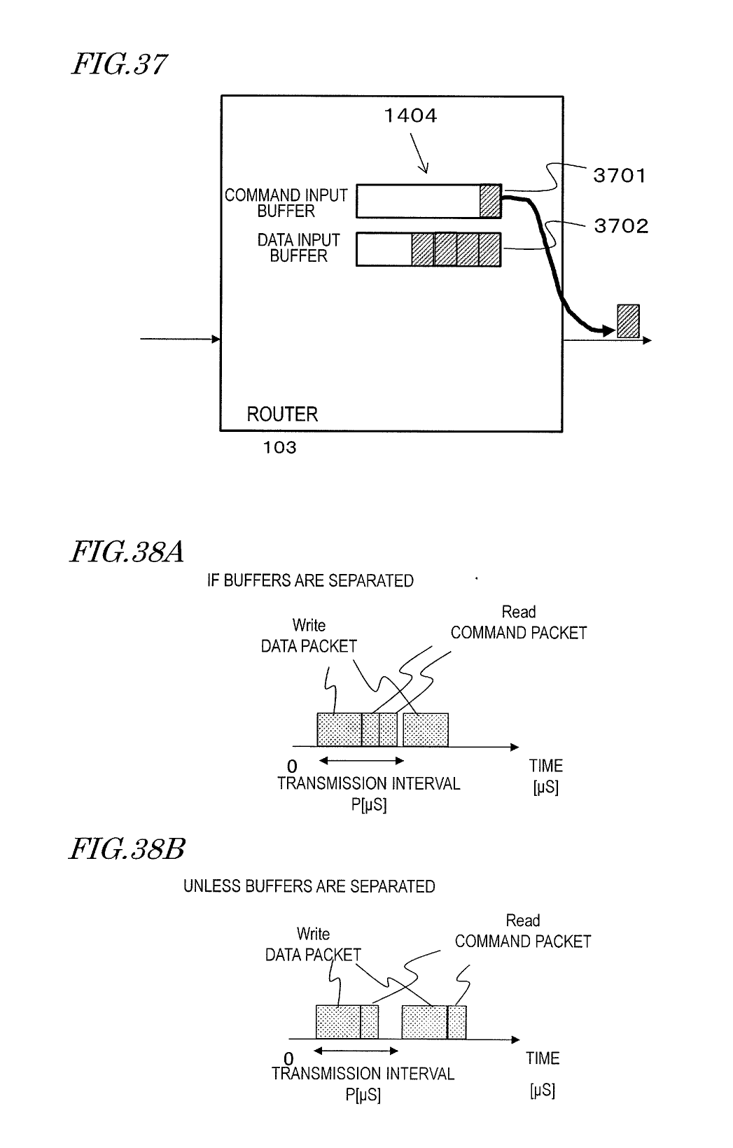

FIG. 37 illustrates an exemplary buffer arrangement to be adopted in a situation where a command and data are separated from each other. No rate control is carried out on the command and a rate control is carried out only on the data. In this embodiment, a configuration in which buffers are physically separated is supposed to be used. However, as long as the buffers are logically separated, the buffers do not have to be physically separated from each other.

FIGS. 38A and 38E show how the delay involved with a command can be shortened, which is an effect to be achieved by separating the command and data from each other.

In FIG. 37, the router 103 includes an input buffer section 1404 including a command input buffer 3701 and a data input buffer 3702. By separately providing input buffers 1405 for the command and the data in this manner, transmission can be changed between the command and the data, and their mutual interference can be reduced. Suppose while the packets of Write access data in Class A which are stored in the input buffer 3702 have their transmission stopped by the rate control, the packets of a Read access command which do not have to be subjected to any rate control arrive and get stored in the command input buffer 3701. In that case, the router 103 can start transmitting the Read access packets immediately thanks to the effect achieved by the separate arrangement. FIG. 38A illustrates at what times those packets are transmitted in a situation where input buffers 1405 are separately provided for the command and the data.

On the other hand, if those packets should be stored in the same input buffer in the order of arrival and unless the transmission could be changed between those packets (e.g., if the input buffer was implemented as a single FIFO), then the Write access packets that have arrived earlier would have their transmission stopped by the rate control and the Read access packets that have arrived later would have their transmission stopped by being affected by the Write access packets that precede them. FIG. 38B shows packet transmission times in a situation where the transmission cannot be changed between the packets. In that case, the packets that should be stored in the same input buffer would interfere with each other to cause an increased delay, and therefore, the operating frequency to ensure the required performance should be estimated to be higher than in the situation shown in FIG. 38A.

That is why by adopting a method in which input buffers are provided separately for the Write data packets to be subjected to the rate control and for the Read command packets not to be subjected to the rate control and in which the transmission can be changed between those two groups of packets, the transmission delay of the Read command packets can be reduced. As a result, the time delay to be caused at the router due to their mutual influence can be reduced and the bus' operating frequency to ensure the required performance can be lowered.

Next, a method for increasing the throughput of a particular master per transmission interval and reducing the estimated operating frequency required by transmitting multiplexed packets will be described.

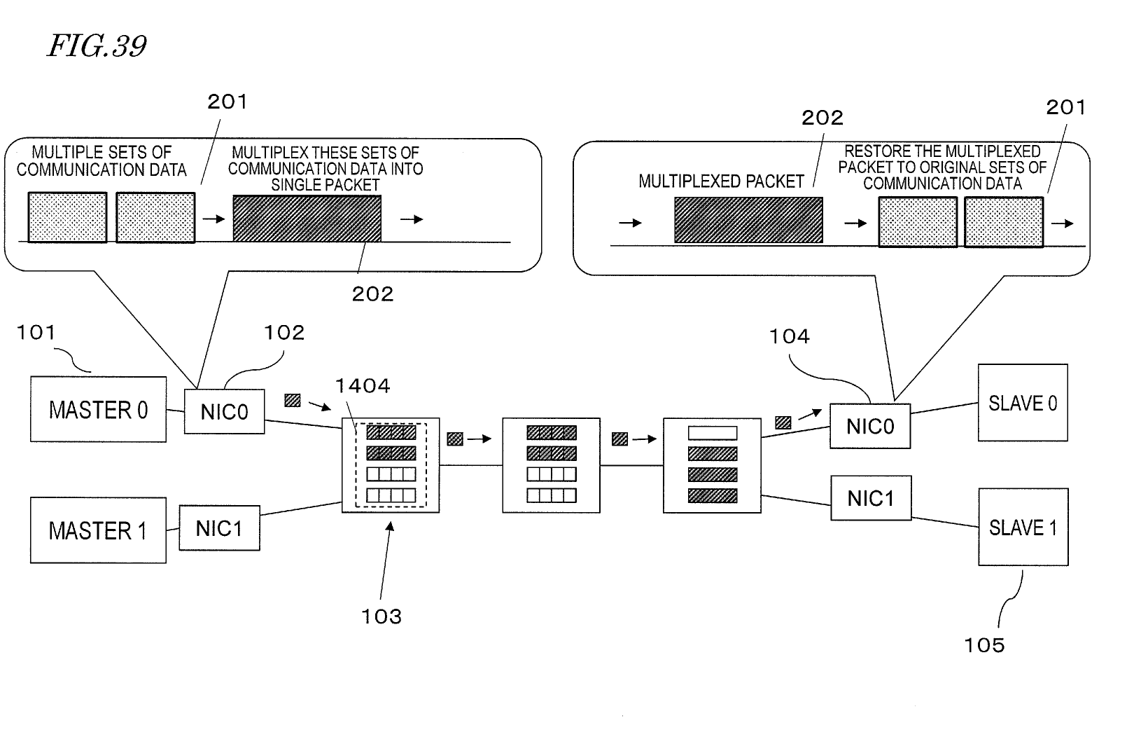

FIG. 39 shows generally how to multiplex and transmit a packet. In this description, “to multiplex a packet” means that the master NIC 102 generates a single packet based on multiple sets of communication data. The inverse processing of the “packet multiplexing” is “packet demultiplexing”. The slave NIC 104 demultiplexes the multiplexed packet received and restores original sets of communication data.

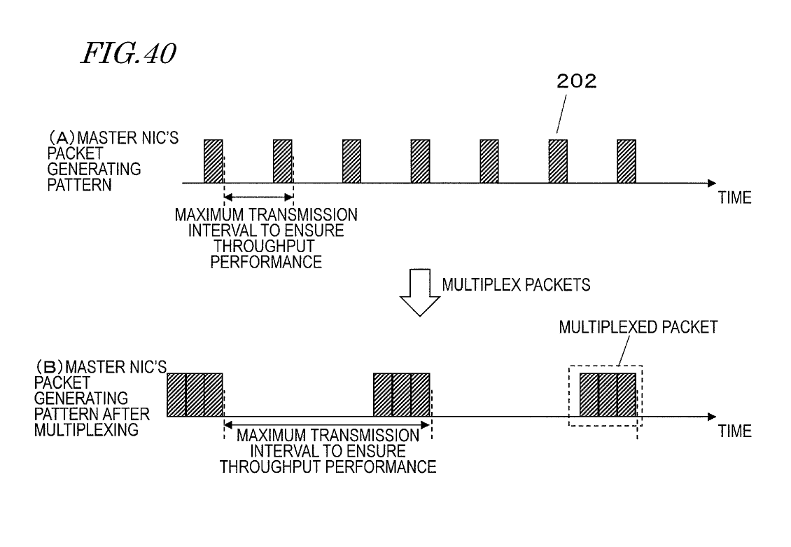

FIG. 40 illustrate how packets may be transmitted depending on whether the packets are multiplexed or not. Portion (A) of FIG. 40 illustrates an example in which the packets are not multiplexed. In this example, a packet is generated for each set of communication data and transmitted. On the other hand, Portion (B) of FIG. 40 illustrates an example in which the packets are multiplexed. In this example, a packet is generated based on multiple sets of communication data and transmitted.

If packets are multiplexed by calculating the “maximum transmission interval that can ensure the throughput performance” with respect to each master based on the specifications required for that master, the maximum transmission interval can be extended by increasing the transmission quantity per transmission interval. A number of masters to be grouped into the same class are controlled by the router at the same transmission interval. That is why if there is a significant difference in the maximum transmission interval that ensures the throughput performance, the transmission interval should be shortened more than necessarily and the estimated operating frequency tends to be an excessive one. For that reason, by transmitting multiplexed packets to a master of which the maximum transmission interval is relatively short within the same class, the maximum transmission interval that can ensure the throughput performance can be extended and the required operating frequency can be lowered.

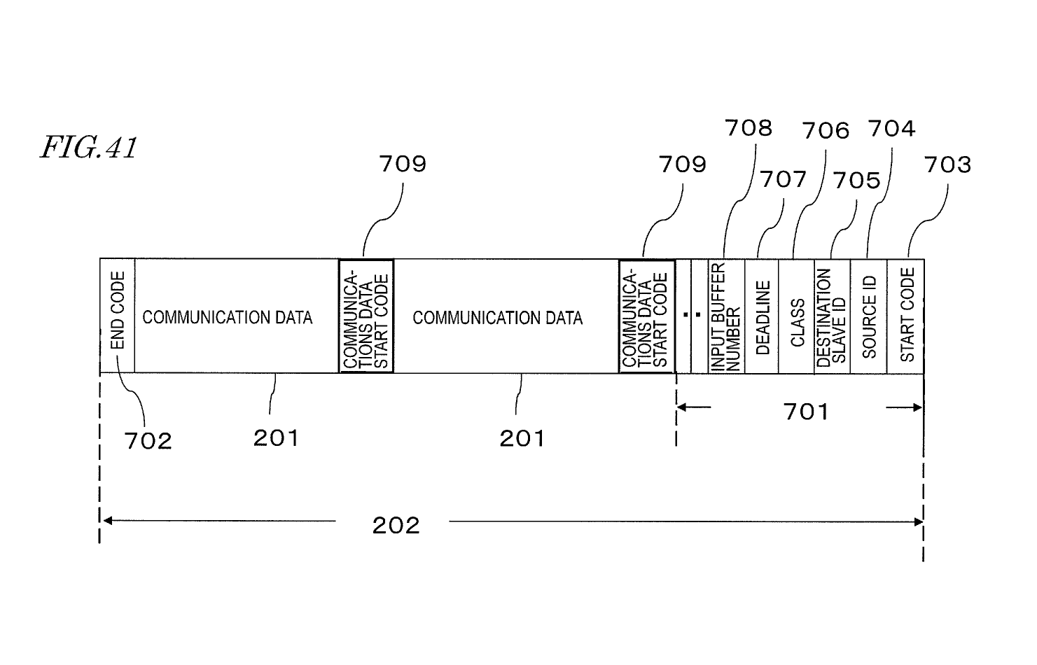

FIG. 41 illustrates a packet multiplexing format for a packet 202. This packet 202 includes not only the packet start code 703 but also a communication data start code 709 at the top of each set of communication data in order to store multiple sets of communication data in a single packet. And the bus system includes a signal line dedicated to transmitting the communication data start code 709. The communication data start code 709 is inserted to a division marker position when communication data is restored, and is transmitted along the packet through the dedicated signal line. By using such a dedicated signal line, packet multiplexing can get done without providing any complicated structure.

In this embodiment, in multiplexing packets, a dedicated signal line is supposed to be used to transmit the communication data start code 709. However, information representing the structure of multiple sets of communication data that have been multiplexed may be added to the header. For example, even if information about the number of sets of the communication data multiplexed and information about the data length of each set of communication data are added to the header, the communication data can also be restored.

To carry out the packet multiplexing, the master NIC 102 may have the same configuration as what is shown in FIG. 12.

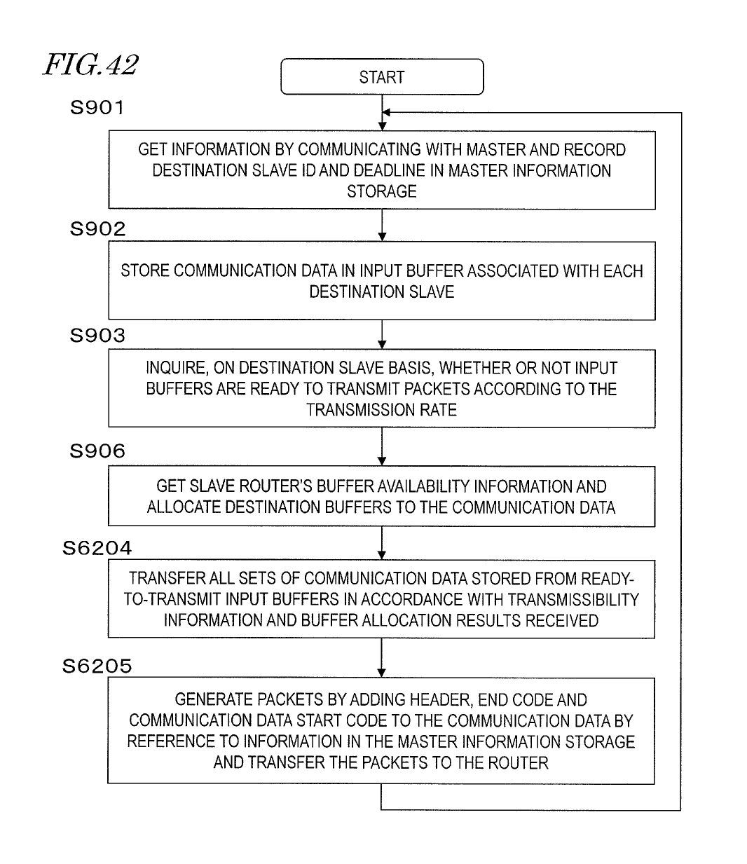

FIG. 42 is a flowchart showing how the master NIC 102 operates to get packet multiplexing done. For the purpose of packet multiplexing, the output changer 805 transfers multiple sets of communication data stored from an input buffer that is ready to transmit packets (in Step S6204). The packet generator 806 adds the communication data start code 709 to the top of each of the multiple sets of communication data received and also adds the header 701 and the end code 702 to those sets of data, thereby generating a packet (in Step S6205).

In determining how many sets of data should be multiplexed together, the number does not have to be the number of the sets of communication data stored as described above. For example, if a master issues a traffic flow only in a predetermined pattern, its behavior can be completely predicted during the design process, and therefore, the number of the sets of data to be multiplexed together may also be determined during the design process. On the other hand, if a master issues a traffic flow in an irregular pattern, a single packet may be transmitted when a preset packet length is reached.

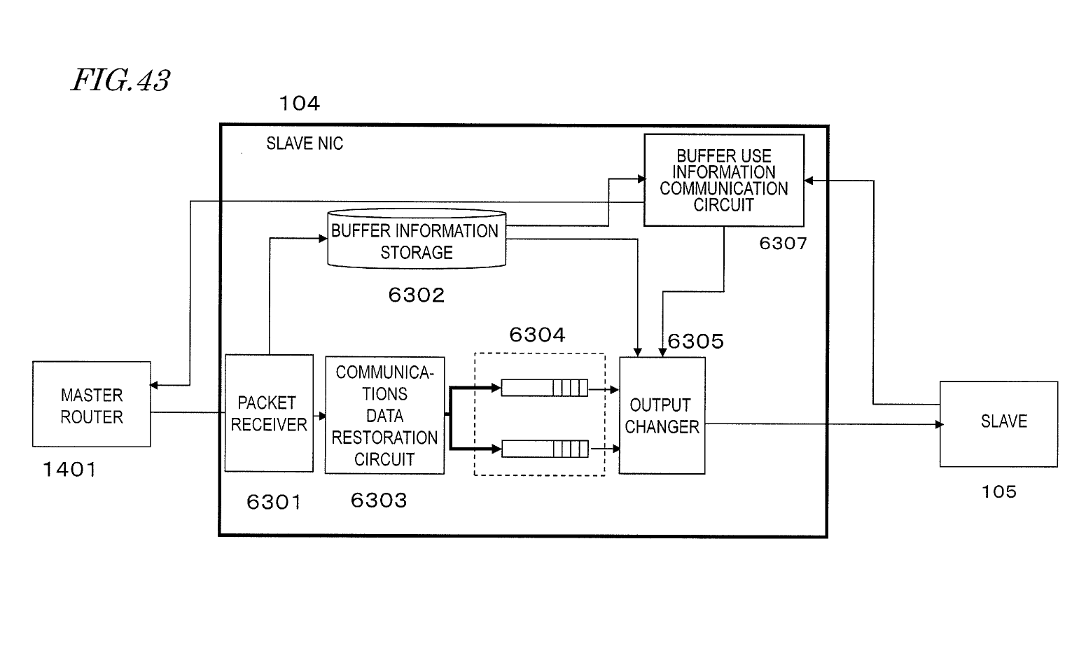

FIG. 43 illustrates a packet multiplexing configuration for the slave NIC 104, which includes a communication data restoration circuit 6303 to restore multiple sets of communication data from the multiplexed packet. Besides the communication data restoration circuit 6303, the slave NIC 104 further includes a packet receiver 6301 which receives a packet, a buffer information storage 6302 which stores information about the packet (including its source ID, deadline and class), an input buffer section 6304 which stores the restored communication data, a buffer use information communication circuit 6307 which gets the slave's (105) buffer availability information from the slave 105 and which provides buffer availability information of the slave NIC 104 for the master router 1401, and an output changing section 6305 which allocates the number of the buffer to store at the slave end by reference to the buffer availability information, class and source ID and which determines the order of transmission based on the deadline and the class.

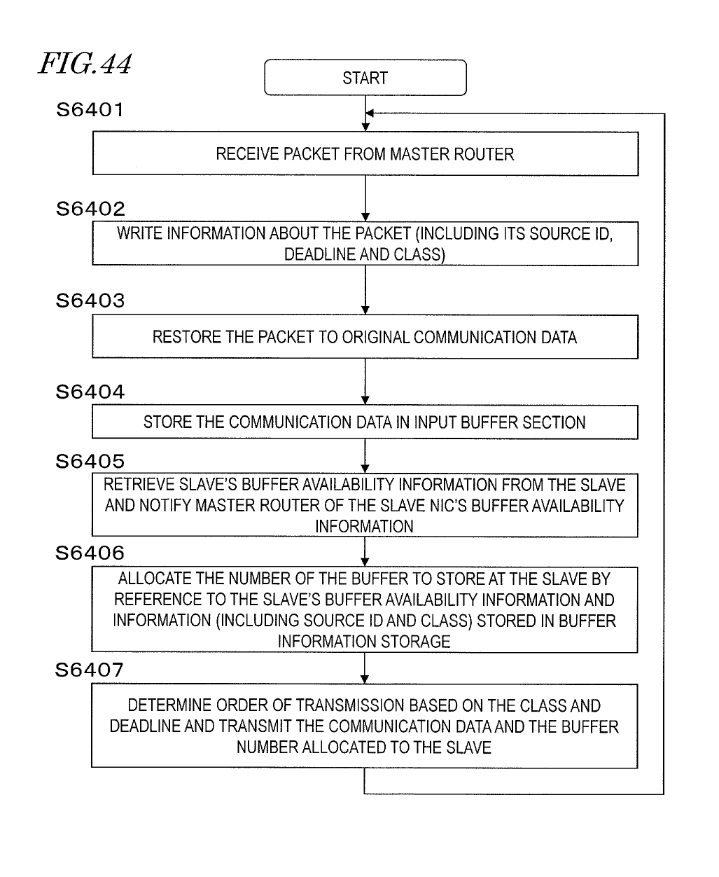

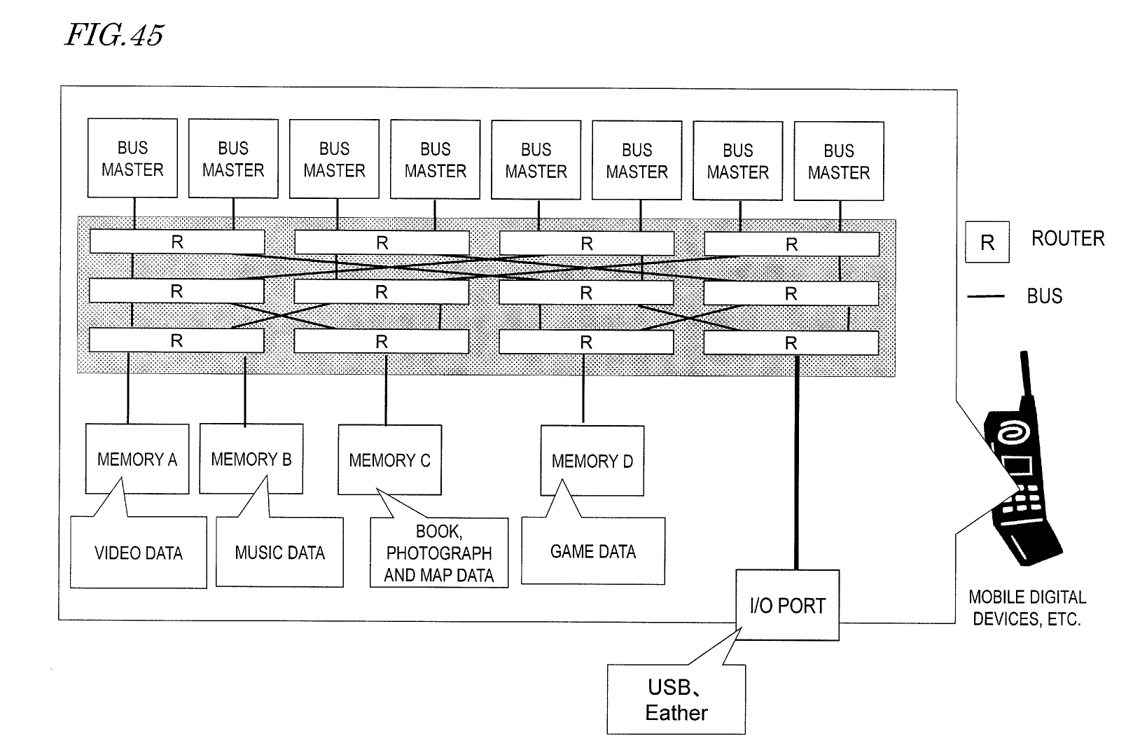

FIG. 44 shows the flow of packet multiplexing operation of the slave NIC 104. First of all, the packet receiver 6301 receives a packet 202 from the master router (in Step S6401) and writes information about the packet (including its source ID, deadline and class) in the packet information storage section 6302 (in Step S6402). Next, the communication data restoration circuit 6303 removes the header 701 and the end code 702 from the packet and restores the communication data 201 (in Step S6403). In the case of a multiplexed packet, when the communication data is restored, the packet is divided into multiple sets of communication data based on the communication data start code 709 that has been received along with the packet.

The communication data restoration circuit 6303 stores the communication data 201 in the input buffer section 6304 by reference to the input buffer number 708 indicated by the header 701 (in Step S6404).

To allocate the number of the buffer to store at the slave 105, the slave NIC 104 retrieves the slave's (105) buffer availability information from the slave 105. Meanwhile, to allocate the number of the buffer to store at the slave NIC 104, the master router 1401 is notified of the slave NIC's (104) buffer availability information (in Step S6405). Then, the output changing section 6305 allocates the number of the buffer to store at the slave 105 by reference to the slave's buffer availability information gotten and the information (including source ID and class) stored in the buffer information storage 6302 (in Step S6406). Thereafter, the output changing section 6305 determines the order of transmission of the sets of the communication data 202 that are stored in the input buffer section 6304 based on the class and the deadline, and then transmits the communication data 202 and the input buffer number 708 allocated to the slave 105 (in Step S6407).

### Exemplary Application #1

Hereinafter, exemplary applications of a router according to an exemplary embodiment of the present invention to actual devices will be described.

FIG. 45 illustrates an example in which multiple bus masters and multiple memories on a semiconductor circuit and common input/output (I/O) ports to exchange data with external devices are connected together with distributed buses. Such a semiconductor circuit may be used in portable electronic devices such as cellphones, PDAs (personal digital assistants) and electronic book readers, TVs, video recorders, camcorders and surveillance cameras, for example. The masters may be CPUs, DSPs, transmission processing sections and image processing sections, for example. The slaves may be volatile DRAMs and/or nonvolatile flash memories. Also, the input/output ports may be USB, Ethernet™ or any other communications interfaces to be connected to an external storage device such as an HDD, an SSD or a DVD.

When multiple applications or services are used in parallel (e.g., when multiple different video clips or musical tunes are reproduced, recorded or transcoded, when books, photographs or map data are viewed or edited, and/or when games are played), respective masters will access memories while attempting to satisfy different levels of performances required. In such a situation, if the bus' band can be used with maximum efficiency by estimating the minimum required bus bandwidth to ensure the performance required, the cost of product development and implementation can be cut down and the products can be marketed at an accelerated rate.

This can get done by defining the requested bandwidth to be used by a master and the time delay permitted for the master according to the type of the given application or service, by arranging separately buffers which have been grouped into respective classes according to the required performance, and by controlling the transmission using such a scheme. That is to say, the bus' bandwidth to ensure the performance required can be estimated to be a small one by using the extra band more efficiently in this manner while minimizing the interference between multiple traffic flows.

### Exemplary Application #2

Next, an exemplary application of a router according to an exemplary embodiment of the present invention to a multi-core processor will be described.

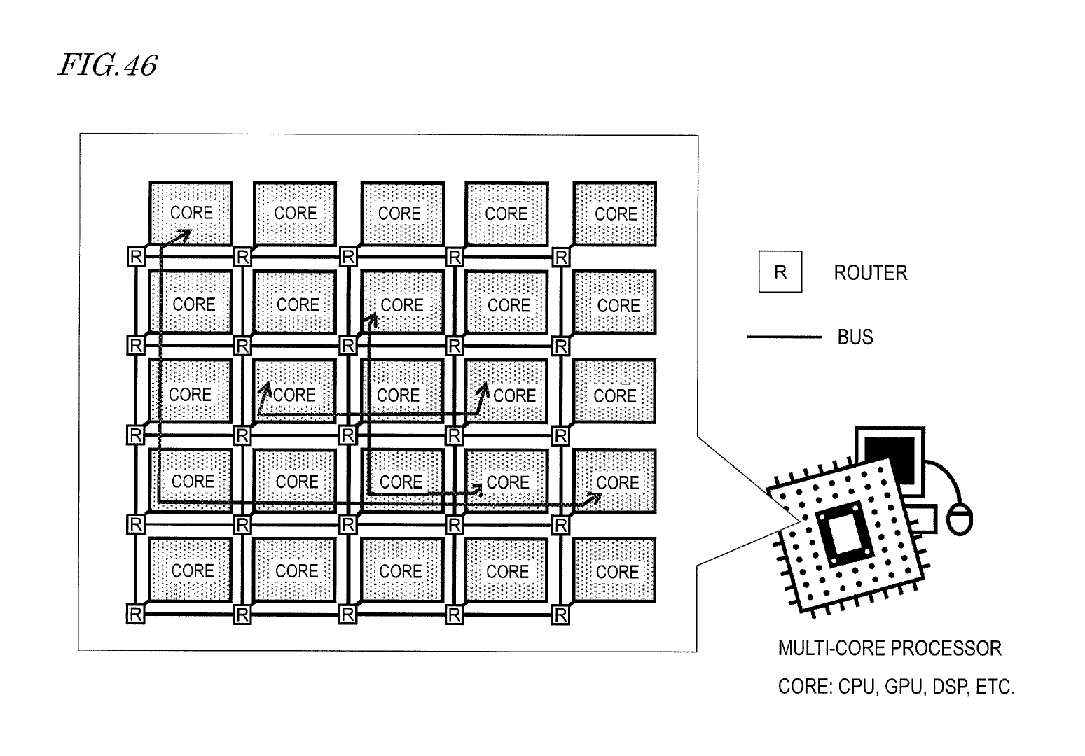

FIG. 46 illustrates a multi-core processor in which a number of core processors such as a CPU, a GPU and a DSP are arranged in a mesh pattern and connected together with distributed buses in order to improve the processing performance of these core processors. In this configuration, each of these core processors may function as either a first node or a second node according to the present invention.

On this multi-core processor, communications are carried out between the respective core processors. For example, each core processor has a cache memory to store necessary data to get arithmetic processing done. And information stored in the respective cache memories can be exchanged and shared with each other between those core processors. As a result, their performance can be improved.

However, the communications are carried out between those core processors on such a multi-core processor at respectively different locations, over mutually different distances (which are represented by the number of routers to hop), and with varying frequencies of communication. That is why if data packets transmitted are just relayed with their order of reception maintained, then applications with high degrees of priority will be interfered with by applications with low degrees of priority and it will take a lot more time to transmit those packets. As a result, the performance of the multi-core processor will decline.

On the other hand, if a router according to an embodiment of the present invention is used, the bus' band can be used highly efficiently and the required bus' bandwidth can be estimated to be an even smaller one by classifying the buffers according to the attributes of an application executed by each CPU. For example, in the case of an application in which a memory needs to be accessed highly frequently, buffers may be grouped into a class with a higher priority level than in other applications. On the other hand, in the case of an application in which a memory needs to be accessed much less frequently on a regular basis and in which an access request can be issued in advance, each traffic flow will be transmitted through the bus for a shorter period of time and the bus' extra band can be used by controlling the transmission rate beyond the requested bandwidth while lowering the priority level. As a result, the performance of each core processor, and eventually the processing time efficiency, can be improved.

### Exemplary Application #3

In the foregoing description, the respective components of the first node, router and second node are represented as individual functional block sections. However, the operation of the router described above may also be performed by getting a program defining the processing of those functional sections executed by a processor (computer) built in the router. The procedure of processing of such a program is just as shown in the various flowcharts that have been referred to in the foregoing description.

In the embodiments and exemplary applications described above, configurations in which the present invention is implemented on a chip have been described. However, the present invention can be carried out not just as such on-chip implementation but also as a simulation program for performing design and verification processes before that on-chip implementation process. And such a simulation program is executed by a computer. In this exemplary application, the respective elements shown in FIG. 12 are implemented as a class of objects on the simulation program. By loading a predefined simulation scenario, each class gets the operations of the respective elements performed by the computer. In other words, the operations of the respective elements are carried out either in series or in parallel to/with each other as respective processing steps by the computer.

A data class that is implemented as router gets such a simulation scenario, which has been defined by a simulator, loaded, thereby setting conditions on not only the class of the bus masters but also determining the timings to send packets that have been received from a class of other routers, destination addresses, the degrees of priority, and the deadlines.

The data class that is implemented as routers performs its operation until the condition to end the simulation, which is described in the simulation scenario, is satisfied, thereby calculating and getting the throughput and latency during the operation, a variation in flow rate on the bus, and estimated operating frequency and power dissipation and providing them to the user of the program. And based on these data provided, the user of the program evaluates the topology and performance and performs design and verification processes.

For example, various kinds of information such as the ID of a node on the transmitting end, the ID of a node on the receiving end, the size of a packet to send, and the timing to send the packet are usually described on each row of the simulation scenario. Optionally, by evaluating a plurality of simulation scenarios in a batch, it can be determined efficiently whether or not the intended performance is ensured by every possible scenario imagined. Furthermore, by comparing the performance with the topology or the number of nodes of the bus and/or the arrangement of the transmitting nodes, the routers and the receiving nodes changed, it can be determined what network architecture is best suited to the simulation scenario. In that case, the configuration of any of the embodiments described above can be used as design and verification tools for this embodiment. That is to say, an exemplary embodiment of the present invention can also be carried out as such design and verification tools.

An embodiment of the present invention is applicable to a router which is configured to maximize, based on quantitative tentative computations, the bus transmission efficiency at a relatively low (e.g., lowest) bus' operating frequency with respect to multiple traffic flows running with mutually different levels of required performances through distributed buses in a semiconductor integrated circuit and yet to ensure performance. That embodiment is also applicable to semiconductor buses to which the QoS technology is incorporated.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A bus system for use in a semiconductor circuit to transmit data between a first node and at least one second node through a network of buses and at least one router which is arranged on any of the buses,
the data to be transmitted including performance-ensuring data which guarantees at least one of throughput and a permitted time delay,
wherein the first node includes:
a packet generator configured to generate a plurality of packets, each of which includes the data to be transmitted and classification information that indicates the class of the data to be transmitted to be determined according to its required performance; and
a transmission controller configured to control transmission of the packets, and
the at least one router includes:
a buffer section configured to store the received packets separately after having classified the packets according to their required performance by reference to the classification information; and
a relay controller configured to control transmission of the packets that are stored in the buffer section at a transmission rate which is equal to or higher than the sum of transmission rates to be guaranteed for every first node associated with the classification information by reference to each piece of the classification information.

2. The bus system of claim 1, wherein the at least one router includes a plurality of routers,
the plurality of routers operate at the same operating frequency, and the respective relay controllers provided for those routers control transmission of the packets at the same transmission rate, and
the same transmission rate is set to be equal to or higher than the maximum one of the transmission rates to be guaranteed by the plurality of routers.

3. The bus system of claim 1, wherein a transmission rate to be guaranteed has been set in advance with respect to each said performance-ensuring data,
the transmission controller controls transmission of packets of the performance-ensuring data either at a predetermined rate which exceeds a transmission rate to be guaranteed by the performance-ensuring data or without imposing a limit to the transmission rate,
the at least one router is able to transmit the packets of the performance-ensuring data at a rate exceeding the transmission rate to be guaranteed by using a first band in which the transmission rate to be guaranteed is able to be maintained and a second band which is an extra band, and
the relay controller classifies, by reference to the classification information, the respective packets of the performance-ensuring data among the plurality of packets that are stored in the buffer section into packets to be transmitted using the first band and packets to be transmitted using the first and second bands, and transmits preferentially the packets to be transmitted using the first band.

4. The bus system of claim 1, wherein the data to be transmitted further includes non-performance-ensuring data which guarantees neither throughput nor permitted time delay,
the transmission controller controls transmission of packets of the non-performance-ensuring data without imposing a limit to their transmission rate,
the buffer section stores the received packets of the non-performance-ensuring data separately, and
the relay controller transmits the packets of the performance-ensuring data and the packets of the non-performance-ensuring data in this order.

5. The bus system of claim 1, wherein the packet generator further gives time information about the deadlines of the packets to the packets, and
as for packets to which the same piece of classification information is given, the relay controller determines the order of transmission of the packets according to their deadlines.

6. The bus system of claim 5, wherein the time information about the deadlines is information about a deadline by which the packets are supposed to arrive at the at least one second node, information about a time when the first node transmitted the packets, information about an accumulated value of processing times by the first node and the router, or information about the value of a transmission counter indicating the order of transmission of the packets from the first node.

7. The bus system of claim 6, wherein if the time information about the deadlines does indicate the deadlines,
the relay controller transmits packets with closer deadlines more preferentially than the other packets.

8. The bus system of claim 3, wherein as for each of the packets to be transmitted using the first and second bands,
the relay controller and the transmission controller determine a rate exceeding a transmission rate to be guaranteed based on the processing ability of a node or link that is going to cause a bottleneck for the bus system.

9. The bus system of claim 1, wherein the performance-ensuring data includes burst data with a burst property and non-burst data with no burst property,
the classification information given by the packet generator is able to distinguish the burst data from the non-burst data,
the buffer section of the at least one router stores the burst data and the non-burst data in the multiple buffers separately, and
the relay controller of the at least one router transmits the packets of the burst data and then the packets of the non-burst data.

10. The bus system of claim 9, wherein the transmission controller of the first node transmits the burst data at a predetermined transmission rate, and
the relay controller transmits at least the burst data at a predetermined transmission rate.

11. The bus system of claim 1, wherein the at least one second node includes a plurality of second nodes, and
the buffer section of the at least one router stores the packets of the respective second nodes in the plurality of buffers separately from each other.

12. The bus system of claim 1, wherein the packets include command-sending packets and data-sending packets, and
the relay controller transmits the command-sending packets without imposing any limit to their transmission rate.

13. The bus system of claim 2, wherein the packets include command-sending packets and data-sending packets, and
the relay controller transmits the command-sending packets without imposing any limit to their transmission rate.

14. The bus system of claim 3, wherein the packets include command-sending packets and data-sending packets, and
the relay controller transmits the command-sending packets without imposing any limit to their transmission rate.

15. The bus system of claim 8, wherein the packets include command-sending packets and data-sending packets, and
the relay controller transmits the command-sending packets without imposing any limit to their transmission rate.

16. The bus system of claim 12, wherein the packets include command-sending packets and data-sending packets, and
the buffer section of the at least one router stores the command-sending packets and the data-sending packets in the plurality of buffers separately from each other.

17. The bus system of claim 2, wherein the packet generator of the first node multiplexes the packets and transmits a resultant multiplexed packet.

18. The bus system of claim 17, wherein the first node that transmits the multiplexed packet and the at least one router include a signal line to transmit information indicating division positions at which the multiplexed packet is restored to respective data.

19. A router arranged on any of buses that form a network in a bus system for a semiconductor circuit to relay data to be transmitted between a first node and at least one second node of the bus system,
wherein the first node generates and transmits a plurality of packets, each of which includes the data to be transmitted and classification information that indicates the class of the data to be transmitted to be determined according to its required performance,
the data to be transmitted includes performance-ensuring data which guarantees at least one of throughput and a permitted time delay, and
the router includes:
a buffer section configured to store the received packets separately after having classified the packets according to their required performance by reference to the classification information; and
a relay controller configured to control transmission of the packets that are stored in the buffer section at a transmission rate which is equal to or higher than the sum of transmission rates to be guaranteed for every first node associated with the classification information by reference to each piece of the classification information.
